(19) United States
(12) Patent Application Publication
(10) Pub. No.: US 2024/0386337 A1
(43) Pub. Date: Nov. 21, 2024

(54) ARTIFICIAL INTELLIGENCE (AI)-POWERED TEST OPTIMIZATION SYSTEM AND METHODOLOGY

(71) Applicant: Dell Products L.P., Round Rock, TX (US)

(72) Inventor: Mahuya Ghosh, Telangana (IN)

(73) Assignee: Dell Products L.P., Round Rock, TX (US)

(21) Appl. No.: 18/317,244

(22) Filed: May 15, 2023

(51) Int. Cl. G06Q 10/04; G06Q 10/0631

(52) U.S. Cl. CPC G06Q 10/04; G06Q 10/0631

(57) ABSTRACT

An example methodology includes, by a computing device, determining a plurality of products associated with a product release, the products including a product that is being released and one or more interlocks linked to the product release. The method also includes, by the computing device, determining a number of features that are to be deployed for each product of the plurality of products and determining a testing that is to be performed for each product of the plurality of products. The method also includes, by the computing device, determining using one or more machine learning (ML) models, a probabilistic time to test the features that are to be deployed for each product of the plurality of products and generating the optimal product deployment sequence for the product release based on a release sequence determined from historical deployments and the probabilistic times to test the features that are to be deployed.

### BACKGROUND

Product release is the process of delivering a product, update, or feature to users (e.g., customers). In the current business environment, it is imperative for developers of products, such as high-technology products, to have frequent releases to ensure both developer and customer success. However, each product release may require a significant amount of testing to ensure that the product functions correctly, is reliable, and is high-quality. For product developers to be successful, such testing needs to be performed without consuming significant resources.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving a request for a recommendation of an optimal product deployment sequence for a product release from another computing device and determining a plurality of products associated with the product release, the plurality of products including a product that is being released and one or more interlocks linked to the product release. The method also includes, by the computing device, determining a number of features that are to be deployed for each product of the plurality of products and determining a testing that is to be performed for each product of the plurality of products. The method also includes, by the computing device, determining, using one or more machine learning (ML) models, a probabilistic time to test the features that are to be deployed for each product of the plurality of products, wherein the one or more ML models are configured to determine weights applied to parameters that influence performance of the one or more ML models. The method further includes, by the computing device, generating the optimal product deployment sequence for the product release based on a release sequence determined from historical deployments and the probabilistic times to test the features that are to be deployed and sending information about the optimal product deployment sequence generated for the product release to the another computing device.

In some embodiments, at least one ML model of the plurality of ML models includes a ridge regression algorithm.

In some embodiments, at least one ML model of the plurality of ML models includes a linear regression algorithm.

In some embodiments, at least one ML model of the plurality of ML models includes an XGBoost algorithm.

In some embodiments, the probabilistic time to test the features that are to be deployed for each product of the plurality of products includes a buffer time. In one aspect, the buffer time is determined using the one or more ML models. In one aspect, the buffer time is determined based on a Product Operations Maturity Assessment (POMA) score. In one aspect, the buffer time is determined based on one or more of a user impact, a business impact, or a seasonality.

In some embodiments, the method also includes, by the computing device, determining, for each product of the plurality of products associated with the product release, one or more test cases that are linked to the features that are to be deployed for the product, and assigning to the one or more test cases an impact score, wherein the impact score is determined using the one or more ML models.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a schematic illustration of an example test optimization topology that can be used to deploy products, in accordance with an embodiment of the present disclosure.

FIG. 5 is a block diagram of an illustrative system for test optimization, in accordance with an embodiment of the present disclosure.

FIG. 6 shows an illustrative workflow for a model building process, in accordance with an embodiment of the present disclosure.

FIG. 7 is a diagram illustrating a portion of a data structure that can be used to store information about relevant parameters of a training dataset for training a multi-target machine learning (ML) model to predict a usage signature score and predict a revenue score, in accordance with an embodiment of the present disclosure.

FIGS. 8A and 8B are diagrams illustrating portions of data structures that can be used to store information about relevant parameters of a training dataset for training a machine learning (ML) model to predict a user impact score and predict a business impact score, in accordance with an embodiment of the present disclosure.

FIG. 9 is a diagram illustrating a portion of a data structure that can be used to store information about relevant parameters of a training dataset for training a machine learning (ML) model to predict an impact score/module, in accordance with an embodiment of the present disclosure.

FIG. 10 is a diagram showing an example flow of interactions between various components of machine learning (ML) services of the system of FIG. 5, in accordance with an embodiment of the present disclosure.

FIG. 11 is a diagram illustrating an example optimal product deployment sequence, in accordance with an embodiment of the present disclosure.

FIGS. 12A-12E are pictorial diagrams showing an example user interface (UI) provided by a test optimization service, in accordance with an embodiment of the present disclosure.

FIG. 13 is a flow diagram of an example process for generating and recommending an optimal product deployment sequence for a product release, in accordance with an embodiment of the present disclosure.

FIGS. 14A-14D illustrate an example of generating an optimal product deployment sequence for a product release, in accordance with an embodiment of the present disclosure.

### DETAILED DESCRIPTION

Disclosed herein are computer-implemented structures and techniques for ensuring optimal, impact-based testing for a product release. This can be achieved, according to some embodiments, through artificial intelligence (AI)-assisted test case optimization, real-time progress visualization, and automatic defect triaging capabilities and alerting mechanisms. As a result, the structures and techniques disclosed herein enable impact-based testing of products across releases that is simpler, less time-consuming, and less resource intensive.

Some embodiments leverage machine learning (ML) models to determine an optimal product deployment sequence for a release of a product. The various ML models can be trained or configured by a training dataset to predict deployment parameters for a candidate product release. For example, the training dataset can include data about product releases performed by an organization (e.g., historical product release data). Such historical product release data (sometimes referred to herein as “historical deployment data” or more simply “historical deployments”) can include information about interlocks (e.g., data about products impacted by the product releases). Once trained, the ML models can, in response to input of information about a release of a product (e.g., a new product or feature release), output predictions of a revenue score, usage signature score, a user impact score, and a business impact score for the product release. An optimal product deployment sequence for the product release can be computed based on factors including the product being released, interlocks (also referred to herein as “impact product areas”), deployment region(s), user impact score, business impact score, seasonality, a Product Operations Maturity Assessment (POMA) score, and product release type. The computed optimal product deployment sequence can then be recommended to the organization, and the organization may use the optimal product deployment sequence to release the product (e.g., to deploy the product).

Some embodiments leverage an ML model to predict impact scores for the various modules included in the product being released as well as the modules in the interlock products (e.g., the modules in the products dependent on or impacted by the product being released). In some such embodiments, the predicted impact scores can be used to determine and assign impact scores to the individual test cases linked or otherwise associated with the various modules. These linked or otherwise associated test cases are the test cases that need to be executed when releasing the product. The test cases linked to a module can then be ordered (or “sorted”) based on the assigned impact scores. An optimal number of test cases to execute (or “perform”) during the release of the product can be determined based on the optimal product deployment sequence computed for the product release. The optimal number of test cases to execute can then be recommended to the organization, and the organization may execute the recommended test cases during the release of the product.

Some embodiments provide a real-time analytical dashboard with alerts and intelligent defect triage. The dashboard can be configured, according to some embodiments, to show overall testing progress during a product release, percentage (%) of test coverage, percentage (%) success, percentage (%) failures, and number of defects per product. For the failed test cases (e.g., failed automated test cases), the dashboard can be configured to enable a user, such as a release manager, to generate an alert informing of a defect (e.g., notify team members working on the release of the defect).

Such insights into a product release can enable organizations to achieve more efficient and impact-based testing across product releases at scale without consuming signification resources and compromising on product quality. Additionally, the various embodiments can improve the efficiency (e.g., in terms of processor, memory, and other resource usage) of computer systems and devices used in performing the tests during the release of the products. Various other aspects and features are described in detail below and will be apparent in light of this disclosure.

As used herein, the term “interlock” refers to dependencies in terms of impact. In the context of products, interlock products or interlocking products are products that depend on and are impacted by one another. The products that have interlocks rely on one another to provide a service or functionality. For example, when releasing a feature (e.g., a product feature), the products that have interlocks may need to work in tandem to release the feature on one of the interlocked products. Similarly, the various teams associated with the interlocked products need to work together to release the feature on an interlocked product.

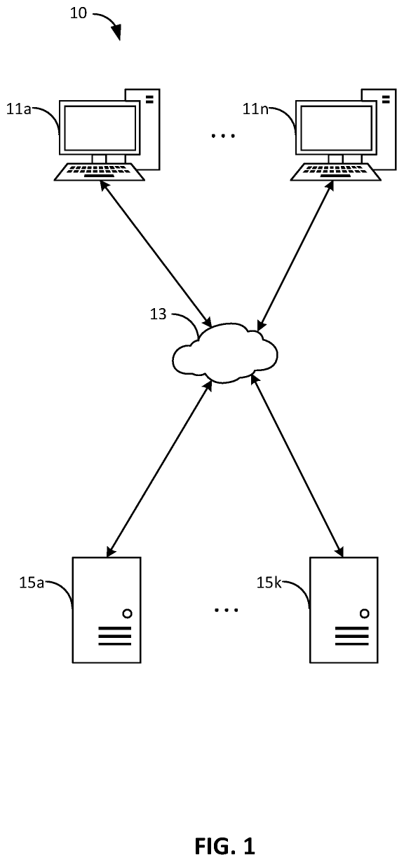

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

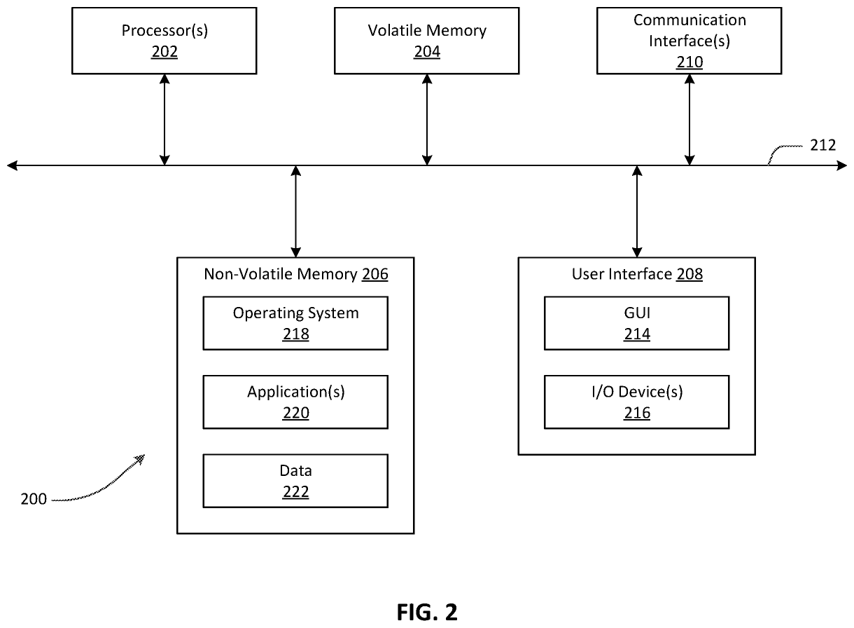

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

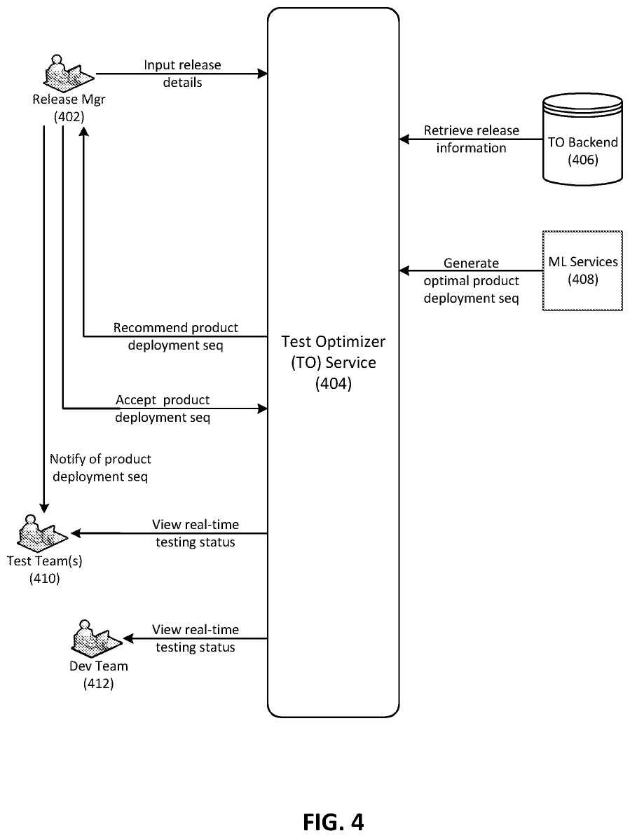

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

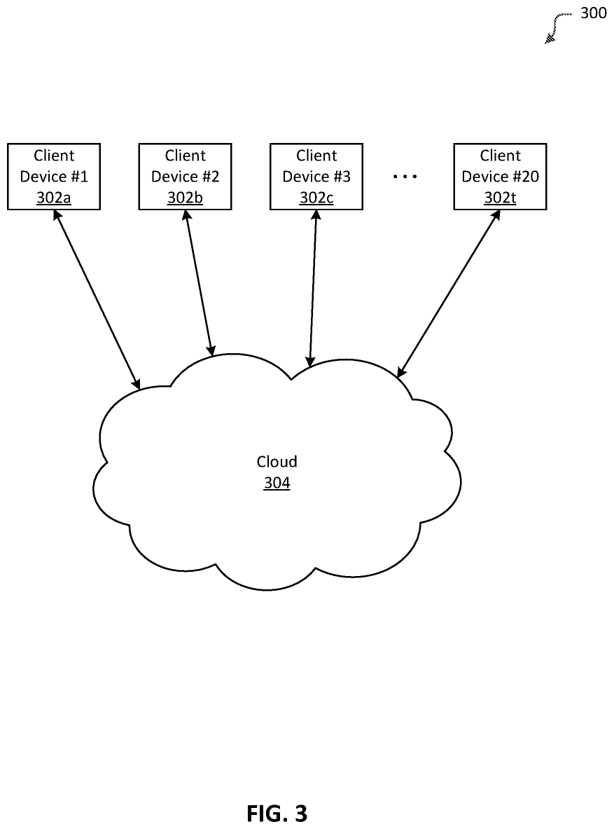

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

Referring to FIG. 4, shown is a schematic illustration of an example test optimization topology that can be used to deploy products, in accordance with an embodiment of the present disclosure. Such a process can be understood as a cyclical process in which a release manager 402 within or associated with an organization leverages the services of a test optimizer (TO) service 404. For example, release manager 402 can use a console provided by TO service 404 to specify information regarding a product release (e.g., information about a release of a product by the organization). The information may include, for example, the product name (e.g., name of the product) and a release number (e.g., an identifier of the release). Release manager 402 can then click/tap a button provided on the console to request a recommendation of an optimal product deployment sequence for the specified product release.

In response, TO service 404 can pull from a TO backend 406 information and details about the specified product release. In certain implementations, TO backend 406 can include a requirement management system, such as JIRA, within which information and data about the organization's products are maintained. For example, based on the inputs provided by release manager 402, TO service 404 can pull (or “retrieve”) the features and stories linked or otherwise associated with the product release from JIRA or other requirement management system utilized by the organization. The features can include information and details about the product such as how a product is to be built (e.g., the modules and components included in the product). The stories can include further details on what needs to be done by various team members to build and release the product (e.g., the test cases to validate the functionality of the modules/components of the product). TO service 404 can determine from the features and stories the complete list of test cases related to the product release. TO service 404 can also determine from the features and stories the interlocks (e.g., the dependent products) which need participate in the product release. TO service 404 can then pull from TO backend 406 the features and stories linked to the dependent products and, from the features and stories determine information and details about the dependent products, such as how each dependent product is to be built, and a complete list of test cases related to releasing each dependent product. TO service 404 can then leverage ML services 408 and the information and details about the specified product release pulled from TO backend 406 to generate an optimal product deployment sequence for the specified product release.

TO service 404 can then recommend the optimal product deployment sequence to release manager 402. In some embodiments, the recommendation can include the number of test cases to be executed and the test case execution order for the product and each of the dependent products (i.e., each of the interlocks). Release manager 402 can review the recommended optimal product deployment sequence and accept the recommendation, for example, using the console provided by TO service 404. Release manager 402 can notify test teams 410 of the product deployment sequence that is being used for the product release. The notification can include information about the test cases which are to be executed by the various test teams 410. In some embodiments, release manager 402 can use the console provided by TO service 404 to notify test teams 410. During the release, members of the various test teams 410 and various development teams 412 can view the real-time testing status. For example, according to some embodiments, the real-time testing status may be displayed within the console provided by TO service 404. In some embodiments, TO service 404 can automatically log defects with information regarding the severity and priority for the failed automated test cases and notify the appropriate team members.

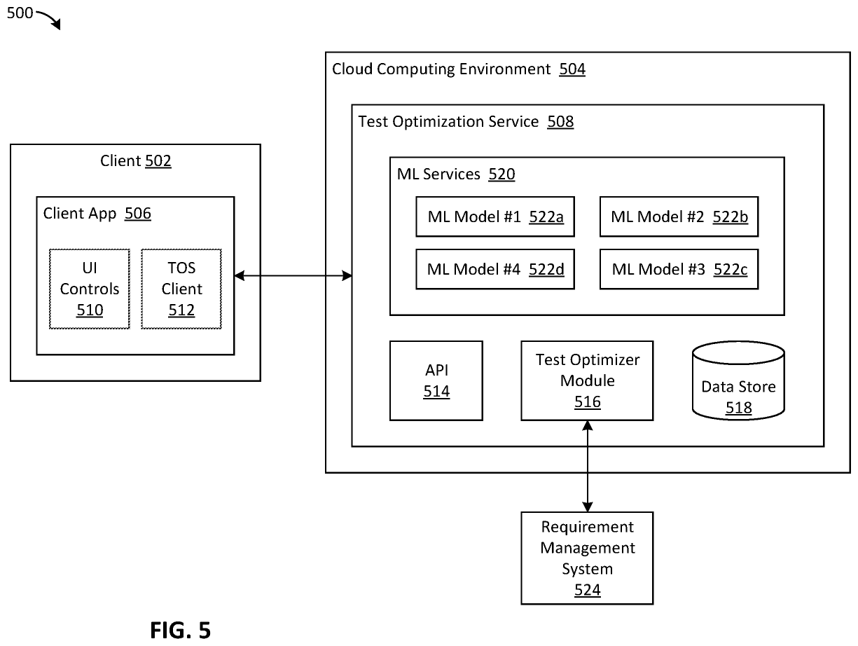

FIG. 5 is a block diagram of an illustrative system 500 for test optimization, in accordance with an embodiment of the present disclosure. Illustrative system 500 includes a client application 506 operable to run on a client 502 and configured to communicate with a cloud computing environment 504 via one or more computer networks. Client 502 and cloud computing environment 504 of FIG. 5 can be the same as or similar to client 11 of FIG. 1 and cloud computing environment 300 of FIG. 3, respectively.

As shown in FIG. 5, a test optimization service 508 can be provided as a service (e.g., a microservice) within cloud computing environment 504. For example, an organization such as a company, an enterprise, or other entity that develops and/or releases products (e.g., software applications, application software, etc.), for instance, may implement and use test optimization service 508. Client application 506 and test optimization service 508 can interoperate to provide optimal, impact-based testing for product releases, as variously disclosed herein. In some embodiments, test optimization service 508 can be the same or similar to TO service 402 of FIG. 4.

To promote clarity in the drawings, FIG. 5 shows a single client application 506 communicably coupled to test optimization service 508. However, embodiments of test optimization service 508 can be used to service many client applications (e.g., client applications 506) running on client devices (e.g., clients 502) associated with one or more organizations and/or users. Client application 506 and/or test optimization service 508 may be implemented as computer instructions executable to perform the corresponding functions disclosed herein. Client application 506 and test optimization service 508 can be logically and/or physically organized into one or more components. In the example of FIG. 5, client application 506 includes UI controls 510 and a test optimization service (TOS) client 512. Also, in this example, test optimization service 508 includes an application programming interface (API) module 514, a test optimizer module 516, a data store 518, and a machine learning (ML) services 520.

The client-side client application 506 can communicate with the cloud-side test optimization service 508 using an API. For example, client application 506 can utilize TOS client 512 to send requests (or “messages”) to test optimization service 508 wherein the requests are received and processed by API module 514 or one or more other components of test optimization service 508. Likewise, test optimization service 508, including components of thereof, can utilize API module 514 to send responses/messages to client application 506 wherein the responses/messages are received and processed by TOS client 512 or one or more other components of client application 506.

Client application 406 can include various UI controls 410 that enable a user (e.g., a user of client 402), such as a release manager or other product team member within or associated with an organization, to access and interact with test optimization service 508. For example, UI controls 510 can include UI elements/controls, such as input fields and text fields, with which the user can specify details about a product release for which recommendation of an optimal product deployment sequence is being requested. The specified product release may be, for example, a release of a new product or new product features that is being released by the organization. UI controls 510 may include, for example, text fields and/or dropdowns which can be used to specify a product name, a product release identifier, and a release start date and time, amount other details, of the product release. In some implementations, some or all the UI elements/controls can be included in or otherwise provided via a console provided by test optimization service 508. UI controls 510 can include UI elements/controls that a user can click/tap to request a recommendation of an optimal product deployment sequence for the specified product release. In response to the user's input, client application 506 can send a message to test optimization service 508 requesting the recommendation of an optimal product deployment sequence for the specified product release.

Client application 506 can also include UI controls 510 that enable a user to view a recommended product deployment sequence for a product release. For example, in some embodiments, responsive to sending a request for a recommendation of an optimal product deployment sequence for a product release, client application 506 may receive a response from test optimization service 508 which includes a recommendation of a product deployment sequence for the specified product release. UI controls 510 can include a button or other type of control/element informing of the recommended product deployment sequence and for accessing the recommended product deployment sequence (e.g., for displaying the recommended product deployment sequence included in the response from test optimization service 508, for example, on a display connected to or otherwise associated with client 402 and/or downloading the recommended product deployment sequence, for example, to client 502). UI controls 510 can also include a button or other type of control/element for accepting or declining the recommended product deployment sequence for the product release. UI controls 510 can also include a button or other type of control/element for notifying other team members of the product deployment sequence for the product release. The user can then take appropriate action based on the provided recommendation. For example, the user can us the provided controls/elements to accept the recommended product deployment sequence and automatically send notifications to upstream and downstream applications informing of the product deployment sequence selected for the product release.

Client application 506 can also include UI controls 510 that enable a user to view the status of the testing of the product and the interlocks in real-time during the release of the product. For example, users, such as team members working on or otherwise associated with the product release can view in real-time the results of the execution of test cases on the product and the interlocks.

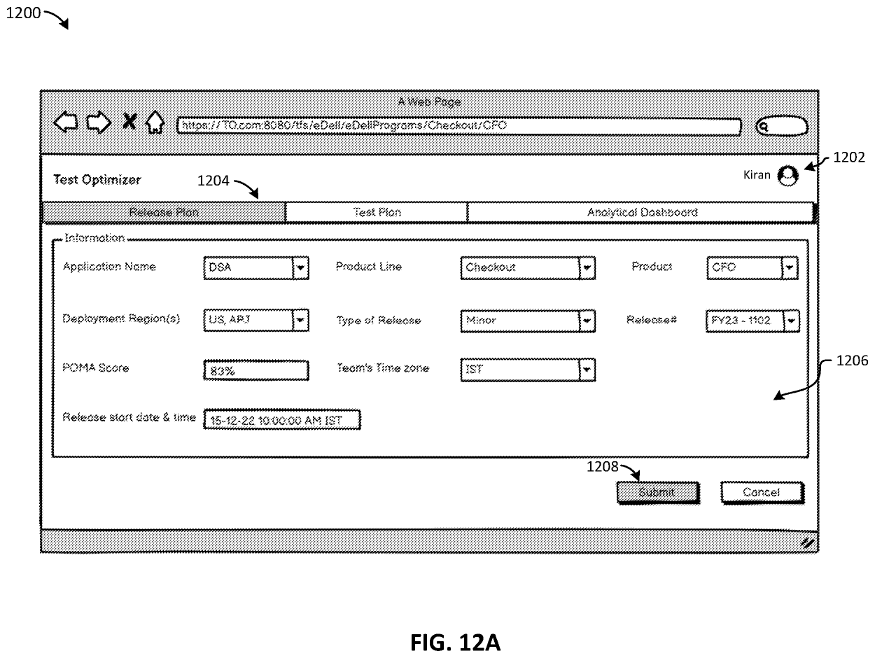

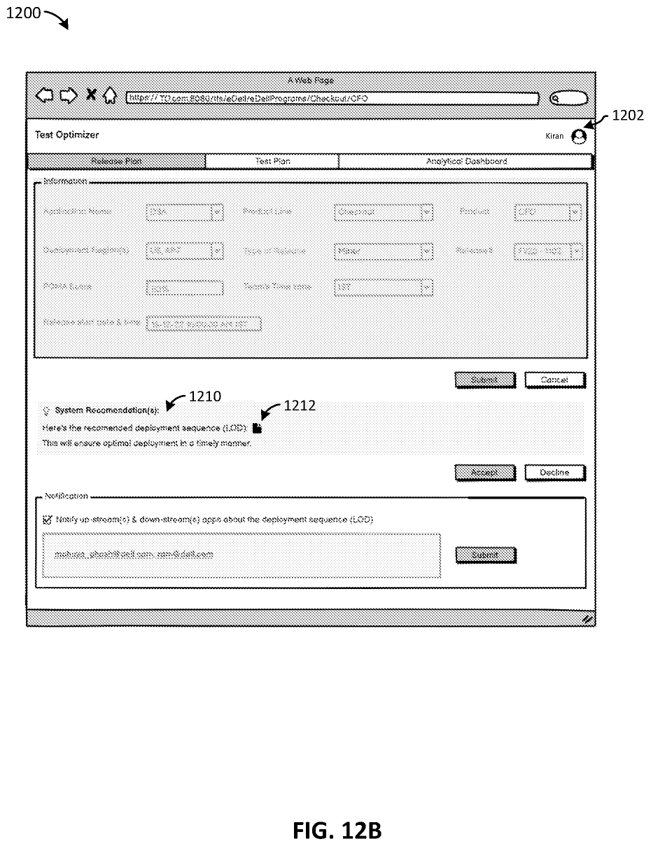

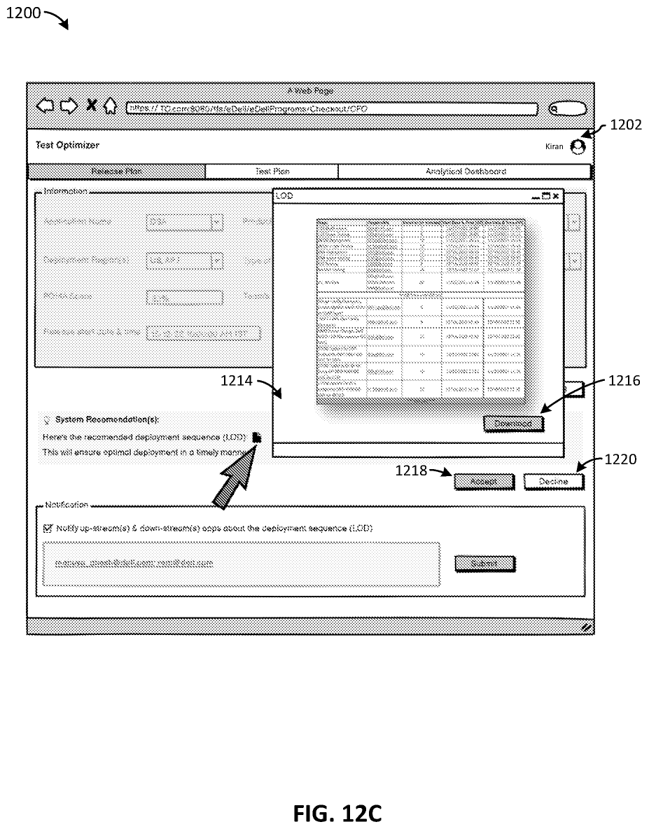

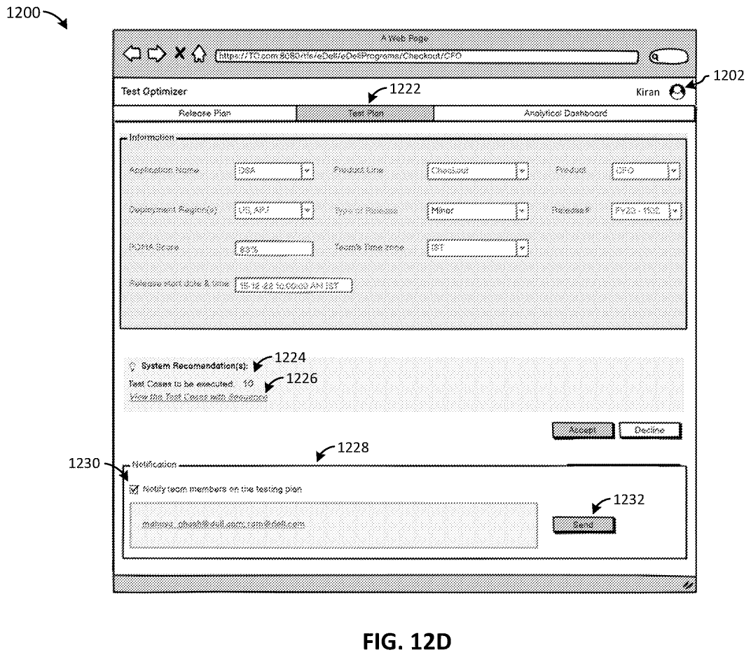

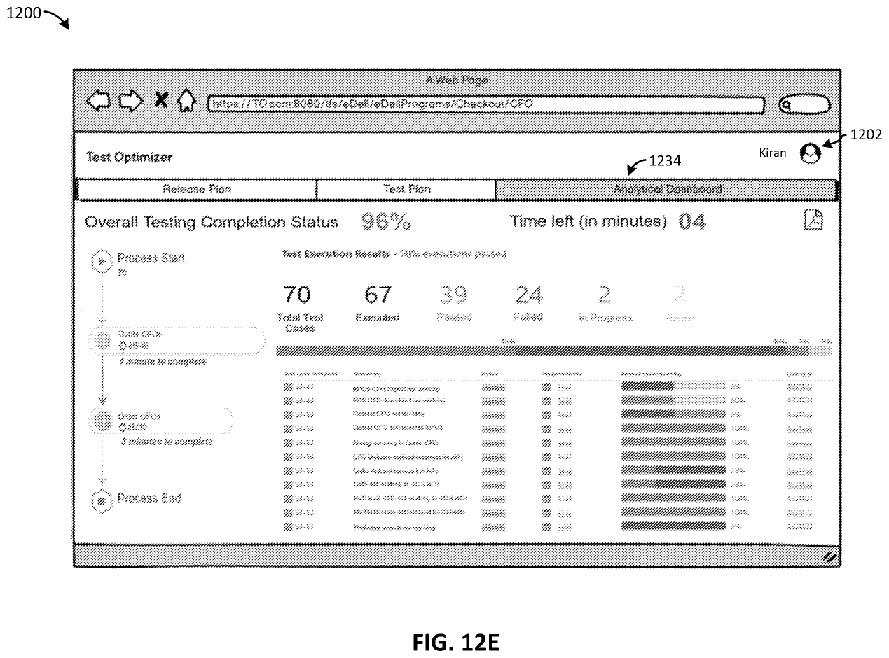

Further description of UI controls 510 and other functionality/processing that can be implemented within client application 506 is provided below at least with respect to FIGS. 12A-12E.

In the embodiment of FIG. 5, client application 506 is shown as a stand-alone client application. In other embodiments, client application 506 may be implemented as a plug-in or extension to another application on client 502, such as, for example, a product release management application. In such embodiments, UI controls 510 may be accessed within the other application in which client application 506 is implemented (e.g., accessed within the product release management application, e.g., JIRA, Team Foundation Server (TFS), etc.).

Referring to the cloud-side test optimization service 508, test optimizer module 516 is operable to generate an optimal product deployment sequence for a product release. In some embodiments, in response to a request for a recommendation of an optimal product deployment sequence for a product release being received by test optimization service 508, test optimizer module 516 can process the received request and provide a recommendation of a product deployment sequence for the specified product release. In particular, according to one embodiment, test optimizer module 516 can retrieve form a requirement management system 524 information and details about the product release. Such information and details can specify how the product is to be built (e.g., information regarding the modules and components included in the product), what needs to be done by various team members to build and release the product (e.g., information regarding the test cases to validate the functionality of the modules/components), specify the interlocks which need participate in the product release and information and details regarding each of the interlocks (e.g., information specifying how each interlock is to be built, the test cases related to each interlock, etc.), and number of features tied to the release (e.g., the number of features to be deployed for each product and interlock). Test optimizer module 516 can then utilize the services of ML services 520 to generate an optimal product deployment sequence for the product release. For example, in one implementation, the optimal product deployment sequence may be based on predictions, such as a revenue score, a usage signature score, a user impact score, a business impact score, and buffer times for performing the different milestones to release the product, generated by ML services 520. Upon generating the optimal product deployment sequence for the product release, test optimizer module 516 can send information about the optimal product deployment sequence in a response to the request for a recommendation of an optimal product deployment sequence. Further details of the predictions generated by ML services 520 are provided below.

Requirement management system 524 may correspond to, for example, various product management systems, such as JIRA and TFS, utilized by or associated with the organization for managing their products. Test optimizer module 516 may utilize an API, such as, for example, a representational state transfer (REST)-based API, provided by requirement management system 524 to collect/retrieve information and materials (e.g., material requirements forecasts) therefrom.

Still referring to test optimizer module 516, in some embodiments, test optimizer module 516 can store the generated optimal product deployment sequence along with other information about the product deployment sequence within data store 518, where it can subsequently be retrieved and used. For example, the optimal product deployment sequence and other materials from data store 518 can be retrieved and used to implement the release of the product. In some embodiments, data store 518 may correspond to a storage service within the computing environment of service test optimization service 508.

In some embodiments, test optimizer module 516 can determine the test cases that are to be executed for the product and each of the interlocks. In one implementation, the test cases to be executed may be based on the impact score assigned to the individual test cases and the optimal product deployment sequence generated for the product release. In one such embodiment, test optimizer module 516 can utilize the services of ML services 520 to generate an impact score for the individual modules of the product/interlocks. Test optimizer module 516 can then assign to the individual test cases an impact score based on the impact score generated for the module. For example, suppose an impact score of two is generated for a module of a product. In this example, test optimizer module 516 may assign to the individual test cases linked to or otherwise associated with the module an impact score of two. Test optimizer module 516 can provide information about the test cases to be executed and the impact scores assigned to the test cases with or as part of the recommended optimal product deployment sequence for the product release. In some embodiments, test optimizer module 516 can determine an order of execution for the test cases based on their impact scores (e.g., order the test cases from highest impact score to lowest impact score). Test optimizer module 516 can provide information about the recommended execution order of test cases with or as part of the recommended optimal product deployment sequence for the product release.

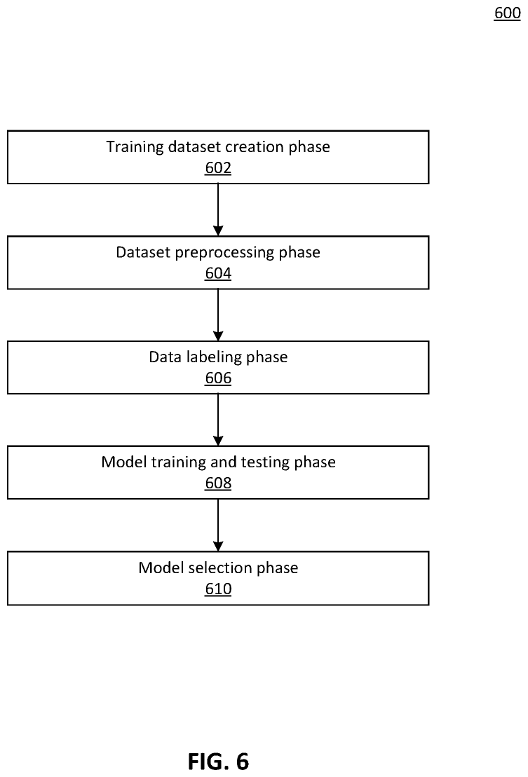

ML services 520 is operable to determine a revenue score, a usage signature score, a user impact score, a business impact score, buffer times for performing the different milestones in a product deployment sequence to release the product (e.g., buffer times for performing the different types of testing during the release), and an impact score for the individual modules of the product/interlocks related to a product release. As can be seen in FIG. 5, in some embodiments, ML services 520 may implement ML models, such as ML models 522a-522d (522 generally), trained for making predictions of deployment parameters for a product release. ML models 522 can be trained or configured for predictions using a training dataset generated from data about product releases performed by the organization (e.g., the organization's historical product release data). Further description of the training and building of ML models 522 is provided below at least with respect to FIGS. 6-9.

In more detail, in some embodiments, ML model 522a can correspond to a linear regression algorithm, such as, for example, a ridge regression algorithm, trained or otherwise configured for prediction of a usage signature score and a revenue score for a product release. The usage signature score indicates the activity level of end users on the product in a particular region and for a particular timeframe. In one implementation, the usage signature score may be on scale from 1 to 10 where 1 indicates very low usage, 2-3 indicate low usage, 4-5 indicate moderately low usage, 6-7 indicate moderate usage, 8-9 indicate high usage, and 10 indicates very high usage. The revenue score reflects the amount of revenue expected to be generated from the product in the particular region. In one implementation, the revenue score may be on a scale from 1 to 10 where 1 indicates very low revenue, 2-3 indicate low revenue, 4-5 indicate moderately low revenue, 6-7 indicate moderate revenue, 8-9 indicate high revenue, and 10 indicates very high revenue. ML model 522a can determine the usage signature score and the revenue score based on parameters such as, for example, product name, product line name, region (e.g., geographical region in which the product is used), number of end users, daily average usage of the product, hourly average usage of the product, day in the week with least usage of the product, weekday peek product usage time interval, weekday off-peek product usage time interval, weekend peek product usage time interval, weekend off-peek product usage time interval, and seasonality affecting product usage (e.g., holidays, sale time, pandemic, environmental hazards, etc.), among others. In response to input of information about a product release (e.g., new product release), ML model 522a can predict a usage signature score and predict a revenue score for the input product release based on the learned behaviors (or “trends”) in the training dataset.

In some embodiments, ML model 522b can correspond to a linear regression algorithm trained or otherwise configured for prediction of a user impact score and a business impact score for a product release. The user impact score indicates the impact on end users due to the key features of the product not being available to them due to various reasons such as system downtime, system deployments, and system upgrades, to provide a few examples. In one implementation, the user impact score may be on a scale from 1 to 10 where 1 indicates very low impact, 2-3 indicate low impact, 4-5 indicate moderately low impact, 6-7 indicate moderate impact, 8-9 indicate high impact, and 10 indicates very high impact. The business impact score indicates the impact on businesses due to the key features of the product not being available to end users and thus affecting sales/revenue booking due to various reasons such as system downtime, system deployments, and system upgrades, to provide a few examples. In one implementation, the business impact score may be on a scale from 1 to 10 where 1 indicates very low impact, 2-3 indicate low impact, 4-5 indicate moderately low impact, 6-7 indicate moderate impact, 8-9 indicate high impact, and 10 indicates very high impact. ML model 522b can determine the user impact score and the business impact score based on parameters such as, for example, product name, product line name, region (e.g., geographical region in which the product, e.g., new capabilities of the product, is being released), user time zone (e.g., time zone associated with the user performing the product release), selected date and time of deployment (e.g., the date and time of deployment of the product), usage signature score (e.g., the usage signature score predicted by ML model 522a), and business score (e.g., the business score predicted by ML model 522a), among others. In response to input of information about a product release (e.g., new product release), ML model 522b can predict a user impact score and predict a business impact score for the input product release based on the learned behaviors (or “trends”) in the training dataset.

In some embodiments, ML model 522c can correspond to a decision-tree-based ensemble machine learning algorithm, such as, for example, an XGBoost algorithm, trained or otherwise configured for prediction of buffer times for performing the different milestones to release the product. ML model 522c can determine the user impact score and the business impact score based on parameters such as, for example, product name, product line name, deployment region (e.g., geographical region in which the product is being deployed), POMA score assigned to the product (e.g., the product's deployment and maturity level), user impact score (e.g., the user impact score predicted by ML model 522b), business impact score (e.g., the business impact score predicted by ML model 522b), seasonality, change failure rate, number of defects raised during deployments, time taken to complete previous deployments, among others. In response to input of information about a product release (e.g., new product release), ML model 522c can predict buffer times for performing the different milestones to release the product based on the learned behaviors (or “trends”) in the training dataset.

In some embodiments, ML model 522c is operable to generate an optimal product deployment sequence for a product release. To do so, ML model 522c can obtain the information and details about the product release, such as the modules and components included in the product, the test cases to validate the functionality of the modules/components, the list of interlocks, the modules and components included in each interlock, the test cases to validate the functionality of the modules/components in each interlock, number of features tied to the release (e.g., the number of features to be deployed for the product and each interlock), and the type of testing that is to be performed. In one implementation, such information and details about the product release may be provided by test optimizer module 516. In other implementations, ML model 522c can retrieve such information and details about the product release form requirement management system 524. For example, ML model 522c can compute an optimal product deployment sequence for the product release based on the information and details about the product release as follows:

y = f(product name, product line name) AND f(# of interlocks)*a1 AND
f(deployment region)*a2 AND f(user impact score)*a3 AND f(business
impact score)*a4 AND f(seasonality in the given region)*a5 AND
f(selected date and time of deployment) AND f(whether the release is a
major/minor release)*a6 AND f(average time of deployment)*a7 AND
f(POMA score)*a8,

where a1-a08 are weights applied to the parameters and are determined based on the training data and the ML models (e.g., ML models 522b and 522c), and which improve over time. Seasonality may indicate whether the release is during a peak season or an off-peak season. Average time of deployment may include the average time taken for each milestone in the deployment (e.g., average time taken for deployment testing of the product, average time taken for scope testing of the product, average time taken for deployment testing of an interlock, average time taken for scope testing of the interlock, end-to-end testing, business testing, etc.). The average time of deployment for each milestone may be computed as a moving average of the past 10 releases with a similar number of features.

The optimal product deployment sequence defines the optimal sequence of milestones and the milestone-related tasks that are to be performed to release the product. In the product deployment sequence, some of the milestones may correspond to the various types of testing that are to be performed during the release.

In some embodiments, ML model 522d can correspond to a decision-tree-based ensemble machine learning algorithm, such as, for example, an XGBoost algorithm, trained or otherwise configured for prediction of an impact score for the individual modules of a product/interlock. The impact score for a module of a product indicates the importance of the module relative to the other modules of the product. That is, the impact score of a module in a product reflects the module's significance based on the extent to which end users use the module in comparison to the other modules in the product. In one implementation, the impact score may be determined at the most granular level (e.g., i.e., by each microservice and APIs). The impact score for the individual modules of a product/interlock may be on a scale from 1 to 10 where 1 indicates very low importance, 2-3 indicate low importance, 4-5 indicate moderately low importance, 6-7 indicate moderate importance, 8-9 indicate high importance, and 10 indicates very high importance. ML model 522d can determine the impact score for the individual modules based on parameters such as, for example, product deployment sequence and usage signature score (e.g., the usage signature score predicted by ML model 522a), among others. For example, ML model 522d can compute an impact score for the individual modules based upon the product deployment sequence and the usage signature score as follows:

y = f(product deployment sequence)*a] AND f(usage signature
score)*b],

where a and b are weights applied to the parameters and are determined based on the training data and the ML models (e.g., ML models 522a and 522d), and which improve over time. Product deployment sequence may be the product deployment sequence (e.g., optimal product deployment sequence) used to release the product. Note that business impact score and user impact score are not input to the model as these are specific to the deployment window. In other words, business impact score and user impact score denote the potential user impact and the potential business impact, respectively, during a given deployment window. ML model 522d can predict an impact score for the individual modules based on the learned behaviors (or “trends”) in the training dataset.

As mentioned previously, test optimizer module 516 can assign impact scores to test cases. An impact score assigned to a test case indicates the quality impact on a product based in terms of value (e.g., monitory value) and user satisfaction. For example, test optimizer module 516 can compute an impact score for the individual test cases based upon the product deployment sequence and the impact score for the module as follows:

y = f(product deployment sequence) AND f(impact score/product
module),

where product deployment sequence is the product deployment sequence (e.g., optimal product deployment sequence) used to release the product. Test optimizer module 516 can determine the test cases that are related to a product release, group the test cases into impact score/product module buckets (e.g., group the test cases according to the modules to which the test cases are linked), and assigned impact scores to the test cases based on the grouping. Test optimizer module 516 can then sort the test cases based on their impact scores and recommend an optimal number of test cases to be executed along with an execution order during the release.

FIG. 6 shows an illustrative workflow 600 for a model building process, in accordance with an embodiment of the present disclosure. Illustrative workflow 600 may be performed to create the various ML models of ML services 520 of FIG. 5. As shown, workflow 600 includes a training dataset creation phase 602, a dataset preprocessing phase 604, a data labeling phase 606, a model training and testing phase 608, and a model selection phase 610.

In more detail, training dataset creation phase 602 can include collecting a corpus of historical product release data from which to generate a training dataset. The corpus of product release data can include the data and information about past product releases made by the organization. In one embodiment, product release data for products released in the past four to six months may be collected from which to create the training dataset. It is appreciated that four to six months of historical product release data is sufficient for capturing the seasonality and hidden characteristics which may influence prediction of the various impact scores and determination of the optimal release times. In some implementations, the historical product release data can be collected or otherwise retrieved from the organization's various enterprise systems, such as, for example, requirement management system 524.

Dataset preprocessing phase 604 can include preprocessing the collected corpus historical product release data to be in a form that is suitable for training the various machine learning algorithms (e.g., the various machine learning algorithms for building the various ML models of ML services 520 of FIG. 5). For example, in one embodiment, natural language processing (NLP) algorithms and techniques may be utilized to preprocess the collected text data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of parameters (also known as features) from the data), stopwords removal, stemming, and/or lemmatization.

The data preprocessing may also include placing the data into a tabular format. In the table, the structured columns represent the parameters (also called “variables”), and each row represents an observation or instance (e.g., a particular training/testing sample). Thus, each column in the table shows a different parameter of the instance. The data preprocessing may also include placing the data (information) in the table into a format that is suitable for training a model. For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The preliminary operations may also include handling of imbalanced data in the training dataset. For example, using a training dataset that contains biased information can significantly decrease the accuracy of the generated ML model (e.g., an ML classification model). For example, in one embodiment, different weights may be assigned to each class (or “category”) in the training dataset. The weight assignment may be done in a manner so that a higher weight is assigned to the minority class and a lower weight (i.e., a lower weight relative to the weight assigned to the minority class) is assigned to the majority class. Here, the idea of weight assignment is to penalize the misclassification by the minority class(es).

The preliminary operations may also include parameter (feature) selection and/or data engineering to determine or identify the relevant or important parameters (features) from the noisy data. The relevant/important parameters are the parameters that are more correlated with the thing being predicted by the trained model (e.g., a revenue score and a usage signature score by ML model 522a, a user impact score and a business impact score by ML model 522b, or an optimal product deployment sequence by ML model 522c). A variety of feature engineering techniques, such as exploratory data analysis (EDA) and/or bivariate data analysis with multivariate-variate plots and/or correlation heatmaps and diagrams, among others, may be used to determine the relevant parameters.

The preliminary operations may also include reducing the number of parameters (features) in the training dataset. For example, since the training dataset may be being generated from four to six months of historical product release data, the number of parameters (or input variables) in the dataset may be very large. The large number of input parameters can result in poor performance for machine learning algorithms. For example, in one embodiment, dimensionality reduction techniques, such as principal component analysis (PCA), may be utilized to reduce the dimension of the training dataset (e.g., reduce the number of parameters in the training dataset), hence improving the model's accuracy and performance.

Data labeling phase 606 can include adding an informative label to each instance in the training dataset. The label added to each instance, i.e., the label added to each training/testing sample, is a representation of a prediction for that instance in the training dataset (e.g., the thing being predicted) and helps a machine learning model learn to make the prediction when encountered in data without a label. The labeled training/testing samples may be used for training or testing an ML model using supervised learning to make the prediction.

Model training and testing phase 608 can include training and testing the ML model (e.g., the various ML models of ML services 520 of FIG. 5) using the training dataset. For example, various tree-based ensemble algorithms such as the XGBoost algorithm and the ADABoost algorithm, various linear regression algorithms such as a linear regression algorithm, a logistic regression algorithm, a ridge regression algorithm, a lasso regression algorithm, a polynomial regression algorithm, and a Bayesian linear regression algorithm, and/or other suitable learning algorithm, may be trained and tested. In one embodiment, the training dataset can be separated into two groups: one for training the ML model and the other for testing (or “evaluating”) the ML model. For example, based on the size of the training dataset, approximately 80% of the training dataset can be designated for training the ML model and the remaining portion (approximately 20%) of the training dataset can be designated for testing or evaluating the ML model. The model can then be trained by passing the portion of the training dataset designated for training and specifying a number of epochs. An epoch (one pass of the entire training dataset) is completed once all the observations of the training data are passed through the model. The model can be tested using the portion of the training dataset designated for testing (or “testing dataset”) once the model completes a specified number of epochs. For example, the model can process the training dataset and a loss value (or “residuals”) can be computed and used to assess the performance of the model. The loss value indicates how well the model is trained. Note that a higher loss value means the model is not sufficiently trained. In this case, hyperparameter tuning may be performed to choose the optimal parameter for the selected learning algorithm. For example, hyperparameter tuning may be performed using a grid search algorithm or other suitable tuning algorithm/technique that attempts to compute the optimum values of hyperparameters. Hyperparameter tuning allows the model to tune the performance based on the characteristics of the data and multiple combinations of model parameters (e.g., max depth, maxBins, stepSize, and subsampling rate). Once the loss is reduced to a very small number (ideally close to 0), the model is sufficiently trained for prediction. In one implementation, k-fold cross validation (where k is an integer) may be used to train and test the models.

Model selection phase 610 can include selecting an appropriate ML model for making the intended prediction(s) (e.g., an appropriate model for each of the ML models of ML services 520 of FIG. 5). Selection of an appropriate ML model may be based on the prediction performance of the various machine learning algorithms trained and tested in model training and testing phase 608. According to one embodiment, model selection phase 610 can include selecting a ridge regression model for ML model 522a, a linear regression model for ML model 522b, an XGBoost model for ML model 522c, and an XGBoost model for ML model 522d of FIG. 5.

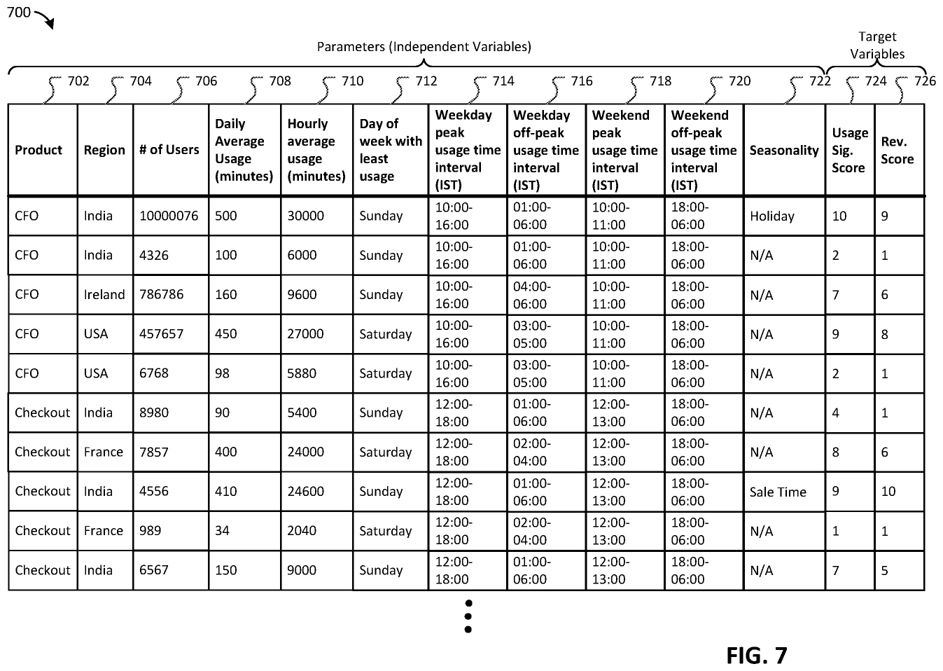

FIG. 7 is a diagram illustrating a portion of a data structure 700 that can be used to store information about relevant parameters of a training dataset for training a multi-target machine learning (ML) model to predict a usage signature score and predict a revenue score, in accordance with an embodiment of the present disclosure. For example, the training dataset including the illustrated parameters, as well as other parameters generated from historical product data (e.g., data and information about products released in the past four to six months), may be used to train a linear regression algorithm, such as, for example, a ridge regression algorithm, to predict a usage signature and predict a revenue score for a product. As can be seen in FIG. 7, data structure 700 may be in a tabular format in which the structured columns represent the different relevant parameters (variables) regarding the training/testing samples and a row represents individual training/testing samples. The relevant parameters illustrated in data structure 700 are merely examples of parameters that may be extracted from product release data used to generate a training dataset and should not be construed to limit the embodiments described herein.

As shown in FIG. 7, the relevant parameters may include a product 702, a region 704, a number of users 706, a daily average usage 708, a hourly average usage 710, a day of the week with least usage 712, a weekday peak usage time interval 714, a weekday off-peak usage time interval 716, a weekend peak usage time interval 718, a weekend off-peak usage time interval 720, a seasonality 722, a usage signature score 724, and a revenue score 726. Product 702 indicates a name or identifier assigned to a product (e.g., name of the product). Region 704 indicates a geographical region associated with the product (e.g., geographical region in which the product is used by end users). Number of users 706 indicates the number of end users using the product in the given region. Daily average usage 708 indicates the average amount (e.g., minutes) the product is used in a day in the given region. Hourly average usage 710 indicates the average amount (e.g., minutes) the product is used in an hour (i.e., 60 minutes) in the given region. Day of week with least usage 712 indicates the day of the week the product is least used in the given region. Weekday peak usage time interval 714 indicates the time interval the product is most used on weekdays (i.e., Monday, Tuesday, Wednesday, Thursday, and Friday) in the given region. Weekday off-peak usage time interval 716 indicates the time interval the product is least used on weekdays (i.e., Monday, Tuesday, Wednesday, Thursday, and Friday) in the given region. Weekend peak usage time interval 718 indicates the time interval the product is most used on weekends (i.e., Saturday and Sunday) in the given region. Weekend off-peak usage time interval 720 indicates the time interval the product is least used on weekends (i.e., Saturday and Sunday) in the given region. Seasonality 722 indicates a season or time of year (e.g., holidays, sale time, pandemic, environmental hazards, etc.) in the given region which may impact usage of the product. Usage signature score 724 indicates the activity level of end users on the product in the given region (e.g., “1”=very low usage and “10”=very high usage). Revenue score 726 indicates the amount of revenue expected to be generated from the product in the given region (e.g., “1”=very low revenue and “10”=very high revenue).

In data structure 700, each row may represent a training/testing sample (i.e., an instance of a training/testing sample) in the training dataset, and each column may show a different relevant parameter of the training/testing sample. In some embodiments, the individual training/testing samples may be used to generate a feature vector, which is a multi-dimensional vector of elements or components that represent the parameters in a training/testing sample. In such embodiments, the generated feature vectors may be used for training/testing a multi-target ML model (e.g., ML model 522a of ML services 520 of FIG. 5) to predict a usage signature score and predict a revenue score for a product (e.g., a new product that is being released). The parameters product 702, region 704, number of users 706, daily average usage 708, hourly average usage 710, day of the week with least usage 712, weekday peak usage time interval 714, weekday off-peak usage time interval 716, weekend peak usage time interval 718, weekend off-peak usage time interval 720, and seasonality 722 may be included in a training/testing sample as the independent variables, and usage signature score 724 and revenue score 726 included as two dependent variables (target variables) in the training/testing sample. That is, usage signature score 724 and revenue score 726 are the labels added to the individual training/testing samples. The illustrated independent variables are parameters that influence performance of the multi-target ML model (i.e., parameters that are relevant (or influential) in predicting a usage signature score and a revenue score for a product).

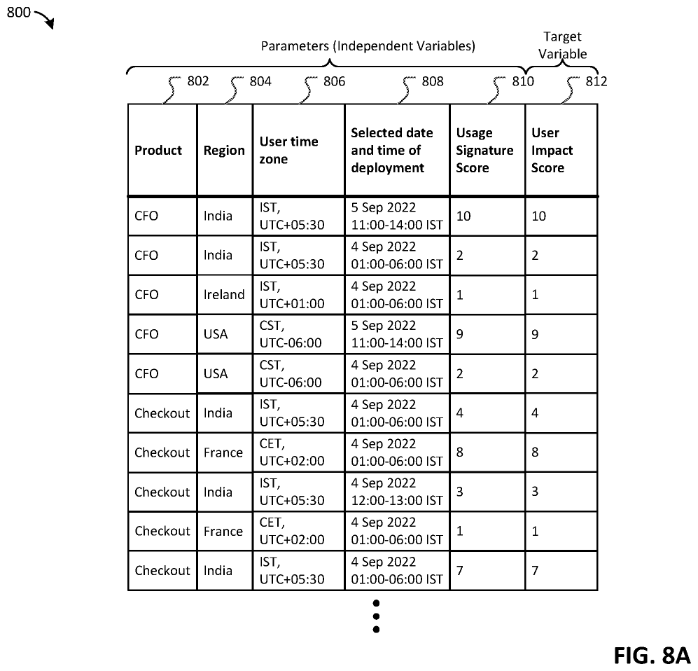

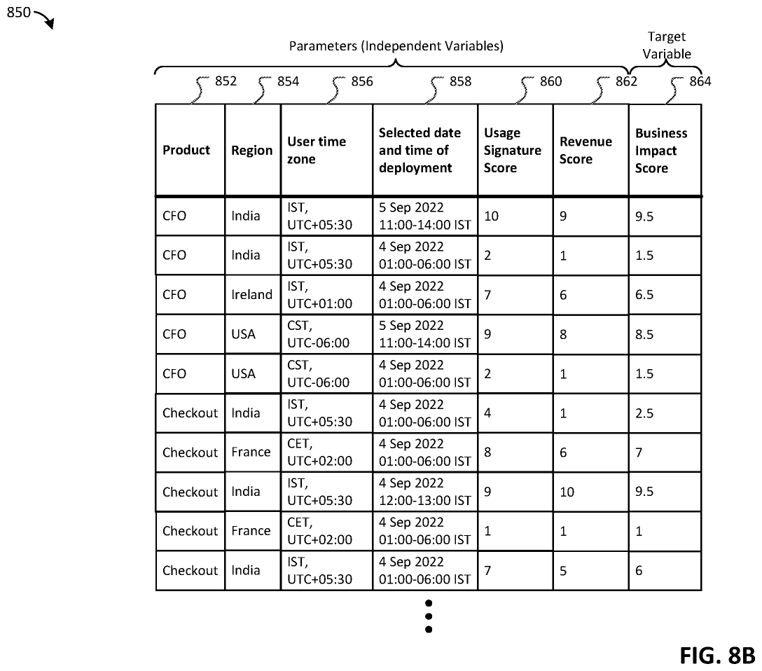

FIGS. 8A and 8B are diagrams illustrating portions of data structures that can be used to store information about relevant parameters of a training dataset for training a machine learning (ML) model to predict a user impact score and predict a business impact score, in accordance with an embodiment of the present disclosure. For example, the training dataset including the illustrated parameters, as well as other parameters generated from historical product release data, may be used to train a linear regression algorithm to predict a user impact score and predict a business impact score for a product release.

Referring to FIG. 8A, shown is a diagram illustrating a portion of a data structure 800 that can be used to store information about relevant parameters of a training dataset for training a machine learning (ML) model to predict a user impact score, in accordance with an embodiment of the present disclosure. For example, the training dataset including the illustrated parameters, as well as other parameters generated from historical product release data, may be used to train a linear regression algorithm to predict a user impact score for a product release. As can be seen in FIG. 8A, data structure 800 may be in a tabular format in which the structured columns represent the different relevant parameters (variables) regarding the training/testing samples and a row represents individual training/testing samples. The relevant parameters illustrated in data structure 800 are merely examples of parameters that may be extracted from product release data used to generate a training dataset and should not be construed to limit the embodiments described herein.

As shown in FIG. 8A, the relevant parameters may include a product 802, a region 804, a user time zone 806, a selected date and time of deployment 808, a usage signature score 810, and a user impact score 812. Product 802 indicates a name or identifier assigned to a product (e.g., name of the product associated with the product release). Region 804 indicates a geographical region associated with the product release (e.g., geographical region in which the product is being released). User time zone 806 indicates the time zone associated with the user performing the product release in the given region. Selected date and time of deployment 808 indicates the date and time selected for the deployment of the product in the given region. Usage signature score 810 indicates the activity level of end users on the product in the given region (e.g., the usage signature score predicted by ML model 522a of ML services 520 of FIG. 5). User impact score 814 indicates the impact on end users due to the key features of the product not being available to the end users in the given region (e.g., “1”=very low impact and “10”=very high impact).

Turning to FIG. 8B, shown is a diagram illustrating a portion of a data structure 850 that can be used to store information about relevant parameters of a training dataset for training a machine learning (ML) model to predict a business impact score, in accordance with an embodiment of the present disclosure. For example, the training dataset including the illustrated parameters, as well as other parameters generated from historical product release data, may be used to train a linear regression algorithm to predict a business impact score for a product release. As can be seen in FIG. 8B, data structure 850 may be in a tabular format in which the structured columns represent the different relevant parameters (variables) regarding the training/testing samples and a row represents individual training/testing samples. The relevant parameters illustrated in data structure 850 are merely examples of parameters that may be extracted from product release data used to generate a training dataset and should not be construed to limit the embodiments described herein.

As shown in FIG. 8B, the relevant parameters may include a product 852, a region 854, a user time zone 856, a selected date and time of deployment 858, a usage signature score 860, a revenue score 862, and a business impact score 864. Product 852, region 854, user time zone 856, selected date and time of deployment 858, and usage signature score 860 can be the same or similar to product 802, region 804, user time zone 806, selected date and time of deployment 808, and usage signature score 810, respectively, discussed above with respect to FIG. 8A. Revenue score 862 indicates the amount of revenue expected to be generated from the product in the given region (e.g., the usage signature score predicted by ML model 522a of ML services 520 of FIG. 5). Business impact score 864 indicates the impact on businesses due to the key features of the product not being available to end users in the given region (e.g., “1”=very low impact and “10”=very high impact).

In data structures 800, 850, each row may represent a training/testing sample (i.e., an instance of a training/testing sample) in the training dataset, and each column may show a different relevant parameter of the training/testing sample. In some embodiments, the individual training/testing samples may be used to generate a feature vector, which is a multi-dimensional vector of elements or components that represent the parameters in a training/testing sample. In such embodiments, the generated feature vectors may be used for training/testing an ML model (e.g., ML model 522b of ML services 520 of FIG. 5) to predict a user impact score and predict a business impact score for a product (e.g., a new product that is being released). In data structure 800, the parameters product 802, region 804, user time zone 806, selected date and time of deployment 808, and usage signature score 810 may be included in a training/testing sample as independent variables, and user impact score 812 included as an independent variable (target variable) in the training/testing sample. That is, user impact score 812 is the label added to the individual training/testing samples. In data structure 850, the parameters product 852, region 854, user time zone 856, selected date and time of deployment 858, usage signature score 860, and revenue score 862 may be included in a training/testing sample as independent variables, and business impact score 864 included as an independent variable (target variable) in the training/testing sample. That is, business impact score 864 is the label added to the individual training/testing samples. In data structures 800, 850, the illustrated independent variables are parameters that influence performance of the ML model (i.e., parameters that are relevant (or influential) in predicting a user impact score and a business impact score for a product).

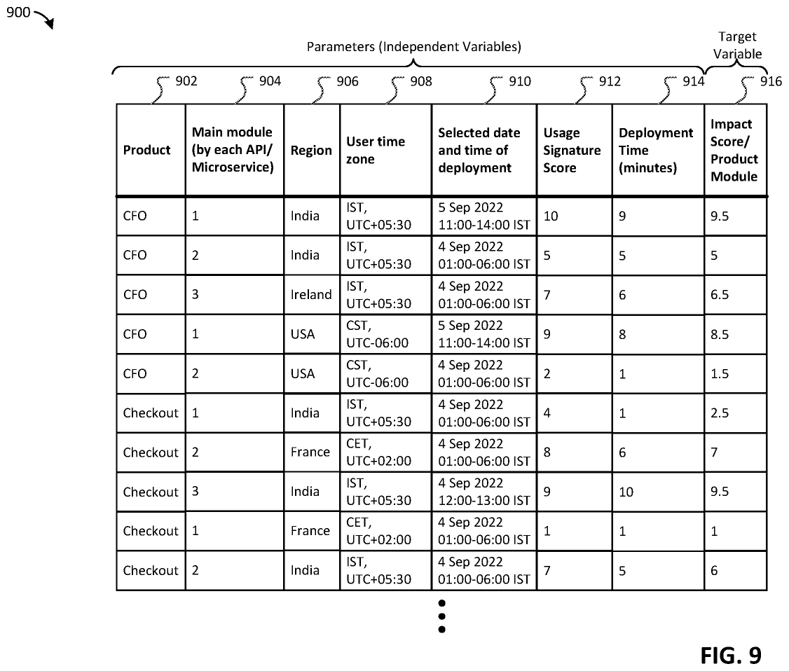

FIG. 9 is a diagram illustrating a portion of a data structure 900 that can be used to store information about relevant parameters of a training dataset for training a machine learning (ML) model to predict an impact score for individual modules of a product/interlock, in accordance with an embodiment of the present disclosure. For example, the training dataset including the illustrated parameters, as well as other parameters generated from historical product release data, may be used to train a decision-tree-based ensemble machine learning algorithm, such as, for example, the XGBoost algorithm, to predict an impact score for individual modules of a product. As can be seen in FIG. 9, data structure 900 may be in a tabular format in which the structured columns represent the different relevant parameters (variables) regarding the training/testing samples and a row represents individual training/testing samples. The relevant parameters illustrated in data structure 900 are merely examples of parameters that may be extracted from product release data used to generate a training dataset and should not be construed to limit the embodiments described herein.

As shown in FIG. 9, the relevant parameters may include a product 902, a main module 904, a region 906, a user time zone 908, a selected date and time of deployment 910, a usage signature score 912, a deployment time 914, and an impact score/product module 916. Product 902 indicates a name or identifier assigned to a product (e.g., name of the product associated with the product release). Main module 904 indicates a module of a product/interlock associated with the product release. The indicated module may be a module that needs testing to deploy the product/interlock as part of the product release. Region 906 indicates a geographical region associated with the product release (e.g., geographical region in which the product is being released). User time zone 908 indicates the time zone associated with the user performing the product release in the given region. Selected date and time of deployment 910 indicates the date and time selected for the deployment of the product in the given region. Usage signature score 912 indicates the activity level of end users on the product in the given region (e.g., the usage signature score predicted by ML model 522a of ML services 520 of FIG. 5). Deployment time 914 indicates the time taken to deploy the product in the given region (e.g., average time taken in the past as indicated by the historical product release data). Impact score/product module 916 indicates the importance of the module relative to the other modules of the product (e.g., “1”=lowest importance and “10”=highest importance).

In data structure 900, each row may represent a training/testing sample (i.e., an instance of a training/testing sample) in the training dataset, and each column may show a different relevant parameter of the training/testing sample. In some embodiments, the individual training/testing samples may be used to generate a feature vector, which is a multi-dimensional vector of elements or components that represent the parameters in a training/testing sample. In such embodiments, the generated feature vectors may be used for training/testing an ML model (e.g., ML model 522d of ML services 520 of FIG. 5) to predict an impact score/product module for a product (e.g., a new product that is being released). The parameters product 902, main module 904, region 906, user time zone 908, selected date and time of deployment 910, usage signature score 912, and deployment time 914 may be included in a training/testing sample as the independent variables, and impact score/product module 916 included as a dependent variable (target variable) in the training/testing sample. That is, impact score/product module 916 is the label added to the individual training/testing samples. The illustrated independent variables are parameters that influence performance of the ML model (i.e., parameters that are relevant (or influential) in predicting an impact score/product module for a product).

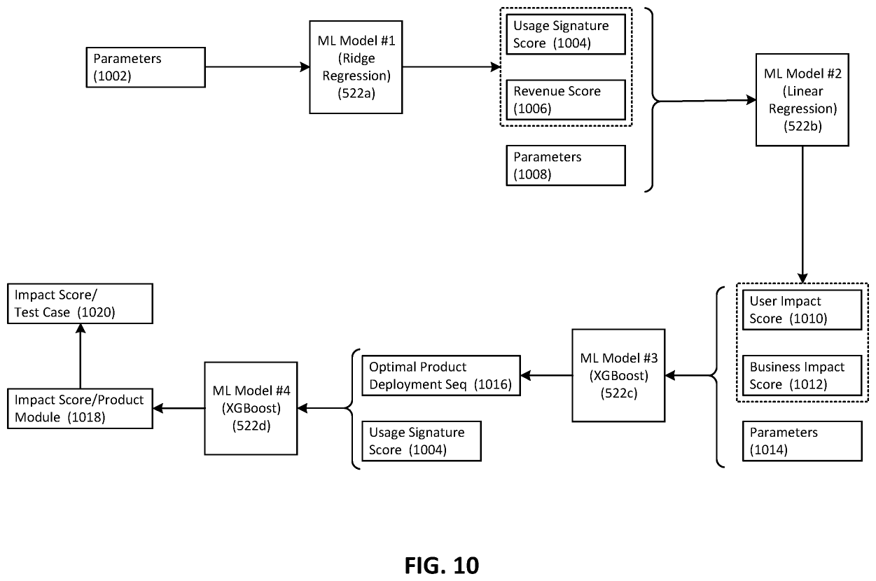

Referring now to FIG. 10 and with continued reference to FIG. 5, shown is a diagram of an example flow of interactions between various components of ML services 520 of system 500, in accordance with an embodiment of the present disclosure. For purposes of this discussion, it is assumed that a release manager within an organization is managing the release of a “Product ABC.”

As shown in FIG. 10, parameters 1002 may be input to ML model 522a. Parameters 1002 may include one or more parameters that are based on the product release information provided by the release manager. Parameters 1002 may also include one or more parameters that are based on data and information about Product ABC. Such data and information may be pulled from the organization's enterprise systems (e.g., requirement management system 524). In any case, parameters 1002 input to ML model 522a include the parameters that influence a prediction of a usage signature score and a prediction of a revenue score by ML model 522a. In response to the input, ML model 522a may output a prediction of a usage signature score 1004 and a prediction of a revenue score 1006 for Product ABC.

Usage signature score 1004 and revenue score 1006 output from ML model 522a may then be input to ML Model 522b along with parameters 1008. Parameters 1008 may include one or more parameters that are based on the product release information provided by the release manager. Usage signature score 1004, revenue score 1006, and parameters 1008 input to ML model 522b include the parameters that influence a prediction of a user impact score and a prediction of a business impact score by ML model 522b. In response to the input, ML model 522b may output a prediction of a user impact score 1010 and a prediction of a business impact score 1012 for Product ABC.

User impact score 1010 and business impact score 1012 output from ML model 522b may then be input to ML Model 522c along with parameters 1014. Parameters 1014 may include one or more parameters that are based on the product release information provided by the release manager. Parameters 1014 may also include one or more parameters that are based on the information about the product release provided by the release manager (e.g., parameters derived from the information provided by the release manager). Such parameters may include, for example, information about the modules and components included in the product, the test cases to validate the functionality of the modules/components, the list of interlocks, the modules and components included in each interlock, the test cases to validate the functionality of the modules/components in each interlock, number of features tied to the release (e.g., the number of features to be deployed for the product and each interlock), and the type of testing that is to be performed. Such information may be pulled from the organization's requirement management systems (e.g., requirement management system 524). User impact score 1010, business impact score 1012, and parameters 1014 input to ML model 522c include the parameters that influence the generation of an optimal product deployment sequence by ML model 522c. In response to the input, ML model 522c may output an optimal product deployment sequence 1016 for releasing Product ABC.

Optimal product deployment sequence 1016 output from ML model 522c and usage signature score 1004 output from ML model 522a may then be input to ML Model 522d. Optimal product deployment sequence 1016 and usage signature score 1004 input to ML model 522d include the parameters that influence a prediction of an impact score for the induvial modules of Product ABC and each interlock by ML model 522d. In response to the input, ML model 522d may output a prediction of an impact score 1018 for the induvial modules of Product ABC and each interlock. Impact score 1018 may then be used to assign an impact score 1020 to the individual test cases. These test cases include the test cases that need to be executed when releasing Product ABC (e.g., include the test cases that need to be executed to release Product ABC).

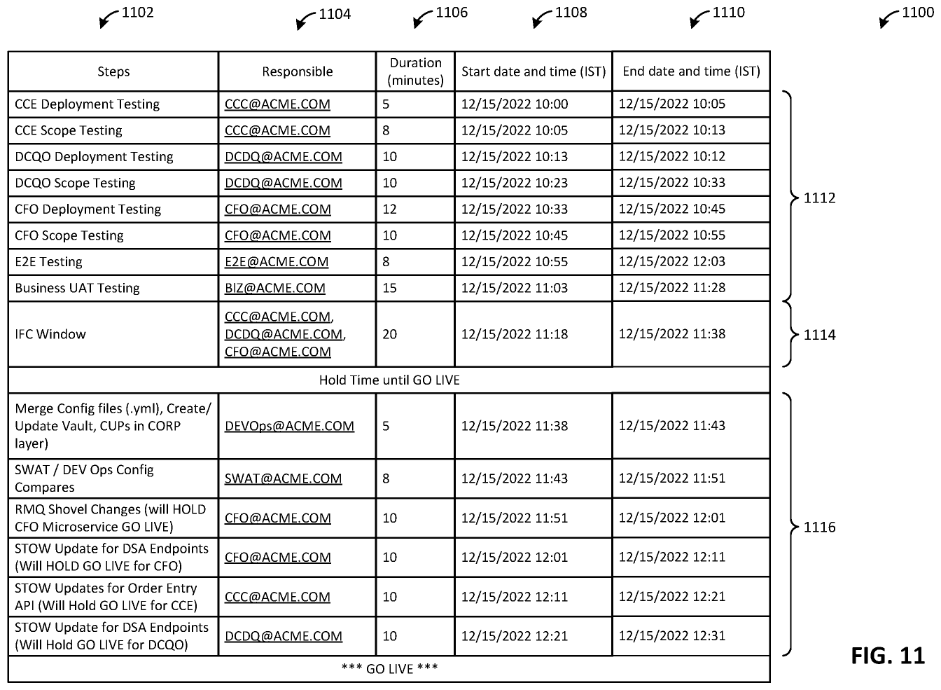

FIG. 11 is a diagram illustrating an example optimal product deployment sequence 1100, in accordance with an embodiment of the present disclosure. Illustrative optimal product deployment sequence 1100 may be generated by test optimization service 508 of FIG. 5 and, in particular, test optimizer module 516 in response to a request for a request for a recommendation of an optimal product deployment sequence. Optimal product deployment sequence 1100 is a simplified example of an optimal product deployment sequence that can be generated by test optimizer module 516 of FIG. 5.

In some implementations, optimal product deployment sequence 1100 may be presented in a tabular format in which each row (or “record” or “entry”) represents an action to that is to be performed and the structured columns represent the attributes of the actions. In the example of FIG. 11, the attributes may include a steps 1102, a responsible 1104, a duration 1106, a start date and time 1108, and an end date and time 1110. Steps 1102 indicate the actions that are to be performed in the deployment sequence. For example, as indicated by the first record, one action is to perform deployment testing of product CCE (as indicated by “CCE Deployment Testing”). As indicated by the second record, another action is to perform scope testing of product CCE (“CCE Scope Testing”). As indicated by the seventh record, another action is to perform end-to-end testing (“E2E Testing”). Responsible 1104 indicates the team member responsible for performing the action. For example, as indicated by the first record, a team member identified by an email address “ccc@acme.com” is responsible for deployment testing of product CCE. Duration 1106 indicates a duration (e.g., minutes) allotted for performing the action. For example, as indicated by the third record, 10 minutes have been allotted to perform deployment testing of product DCQO. Start date and time 1108 and end date and time 1110 indicate a start time and an end time, respectively, for performing the action. For example, as indicated by the second record, scope testing of product CCE is to start at 10:05 on Dec. 15, 2022 (“12/15/2022 10:05”) and end at 10:13 on Dec. 15, 2022 (“12/15/2022 10:13”).

As shown, optimal product deployment sequence 1100 may include time allocated for performing actions to test the product and the interlocks (see reference numeral 1112), performing any needed fixes during the release, e.g., perform hot fixes during the release (see reference numeral 1114), and performing DevOps and configuration activities (see reference numeral 1116). In the example of FIG. 11, optimal product deployment sequence 1100 allocates 78 minutes (5+8+10+10+12+10+8+15) for testing the product and interlocks, 20 minutes for performing any needed fixes during the release, and 53 minutes for DevOps and configuration activities (5+8+10+10+10+10). In some implementations, the actions included in the deployment sequence may be grouped according to the type of activity, as shown in FIG. 11, for example. In some embodiments, the actions in the deployment sequence may be arranged (e.g., sequenced) in the order the actions are to be performed, as shown in FIG. 11, for example.

FIGS. 12A-12E are pictorial diagrams showing an example user interface (UI) 1200 provided by test optimization service 508 of FIG. 5, in accordance with an embodiment of the present disclosure. For example, illustrative UI 1200 may be implemented as part of test optimization service 508 console GUI. In the example of FIGS. 12A-12E and the following description thereof, it is assumed that a user named “Kiran” is logged into and accessing test optimization service 508, as indicated by an icon 1202. Kiran may be a release manager within an organization and using a client (e.g., client 502 of FIG. 5) to access the console of test optimization service 508.

Referring to FIG. 12A, illustrative UI 1200 may display a “Release Plan” page as indicated by an item (or “tab”) 1204. The Release Plan page may include an information pane 1206 which includes input fields and dropdowns for collecting information about a product release. For example, Kiran may use the input fields and dropdowns provided within pane 1206 to specify (or “input”) information about a product release, such as a name of the product (e.g., “Product”), a release number that identifies the product release (e.g., “Release #”), a product line associated with the product (e.g., “Product Line”), a type of product release, such as minor or major (e.g., “Type of Release”), Kiran's time zone (e.g., “Team's Time zone”), a name of an application that includes the product (e.g., “Application Name”), the regions where the product is being deployed, such as US, APJ, Europe, etc. (e.g., “Deployment Region(s)”), a POMA score for the product (e.g., “POMA Score”), and a planned or intended start date and time for the product release (e.g., “Release start date & time”). Upon specifying the product release information, Kiran may click/tap a submit button 1208 to request a recommendation of an optimal product deployment sequence for the specified product release (e.g., recommendation of an optimal product deployment sequence for the product release identified by the specified release number).

Turning to FIG. 12B, in response to a recommendation of an optimal product deployment sequence for the specified product release being received, UI 1200 can display a notification 1210 informing of the availability of the recommendation. Notification 1210 may include an icon 1212 that can be activated to view the recommended optimal product deployment sequence for the product release. For example, Kiran may activate (e.g., click, tap, or select) icon 1212 to request display of the recommended optimal product deployment sequence for the product release.

Turning to FIG. 12C, in response to activation of icon 1212, UI 1200 can display a popup window 1214 that displays the recommended product deployment sequence. Popup window 1214 may also display a download button 1216 that can be used to download a copy of the recommended optimal product deployment sequence onto Kiran's computing device (e.g., client 502 of FIG. 5). For example, Kiran may click/tap on download button 1216 to obtain a copy of the recommended optimal product deployment sequence for the product release. UI 1200 can also display an accept button 1218 that can be used to accept the recommended product deployment sequence and a decline button 1220 that can be used to decline the recommended product deployment sequence. For example, Kiran may click/tap accept button 1218 to accept the recommended product deployment sequence for the product release. In response to accept button 1218 being clicked/tapped, a notification may be sent to test optimization service 508 of the acceptance of the recommended optimal product deployment sequence for the product release.

Turning to FIG. 12D, UI 1200 may display a “Test Plan” page as indicated by an item (or “tab”) 1204. The Test Plan page can display a notification 1224 informing of the number of test cases that are associated with the recommended optimal product deployment sequence. Notification 1224 may include a link 1226 that can be activated to view the test cases associated with the recommended optimal product deployment sequence for the product release. For example, Kiran may activate (e.g., click, tap, or select) link 1226 to view the test cases associated with the recommended optimal product deployment sequence for the product release. The Test Plan page may display a notification pane 1228 which indicates the team members who are on the testing plan for the product release (e.g., includes email address links of the team members). Notification pane 1228 may display a checkbox 1230 that can be selected to indicate a notification be sent to the team members on the testing plan and a send button 1232 that can be used to send a notification to the team members on the testing plan. For example, Kiran may select checkbox 1230 and click/tap send button 1232 to send a notification to the team members indicated in notification pane 1228. In response, test optimization service 508 can send a notification (e.g., an email, text message, etc.) to the team members of the test cases.

Turning to FIG. 12E, UI 1200 may display an “Analytical Dashboard” page as indicated by an item (or “tab”) 1204. The Analytical Dashboard page can display real-time status of the testing being performed during the release of the product. As shown, in the example of FIG. 12E, the Analytical Dashboard page can show a holistic view of the testing that is being performed including the overall testing completion status, the time remaining to perform the testing, the total number of test cases, the number of test cases executed, the number of test cases that passed (e.g., completed successfully), the number of test cases that failed, the number of text cases that are in progress, the number of test cases which needed retesting, and a percentage of test case executions that passed, among other information. In some implementations, the Analytical Dashboard page may include a UI element/control (not shown) that can be used to generate alerts informing of failed test cases (e.g., failed automated test cases). For example, Kiran may click/tap/select the provided UI element/control to send an alert to appropriate team members informing of the failed test cases.

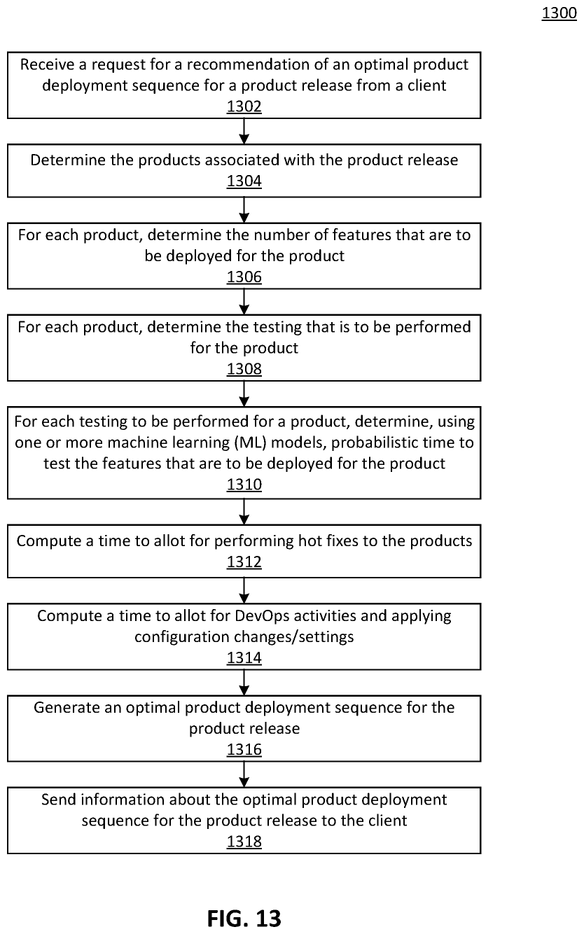

FIG. 13 is a flow diagram of an example process 1300 for generating and recommending an optimal product deployment sequence for a product release, in accordance with an embodiment of the present disclosure. Illustrative process 1300 may be implemented, for example, within system 500 of FIG. 5. In more detail, process 1300 may be performed, for example, in whole or in part by test optimizer module 516, ML services 520, including ML models 522 of ML services 520, or any combination of these including other components of system 500 described with respect to FIG. 5.

With reference to process 1300 of FIG. 13, at 1302, a request for a recommendation of an optimal product deployment sequence for a product release may be received from a client. For example, a user (e.g., a release manager within an organization) may use their client device (e.g., client 502) to specify details about a product release and send a request for a recommendation of an optimal product deployment sequence for the specified product release.

At 1304, the products associated with the product release may be determined. The products associated with the release may include the product that is being released (i.e., the product specified with the request) and any interlocks (e.g., dependent products) linked to the product release.

At 1306, the number of features that are to be deployed may be determined for each product. For example, these features can be understood to be the capabilities/functionalities of the products that are being deployed in the product release.

At 1308, the testing that is to be performed for each product may be determined. Non-limiting examples of the types of testing that can be performed include deployment testing (product testing), scope testing (quality assurance testing), end-to-end testing, business testing, and regression testing. Also, the testing can include fully automated testing, partly automated testing, and manual testing.

At 1310, for each testing to be performed for a product, a probabilistic time to test the features that are to be deployed for the product may be determined. For example, the probabilistic times may be determined using one or more ML models configured to determine weights applied to parameters that influence performance of the one or more ML models (e.g., influence prediction capabilities of the one or more ML models). In some implementations, the time determined for testing the features that are to be deployed for the product may be based on a moving average of the times taken in earlier releases with a similar number of features. In some implementations, the time determined for testing the features that are to be deployed for the product may include a buffer (i.e., a buffer time) which may be determined using one or more ML models.

At 1312, a time to allot for performing hot fixes to the products may be computed. At 1314, a time to allot for DevOps activities and applying configuration changes/settings may be computed.

At 1316, an optimal product deployment sequence for the product release may be generated. For example, the optimal product deployment sequence for the product release may be based on a release sequence determined from historical deployments and the probabilistic times to test the features that are to be deployed for the release.

At 1318, information about the optimal product deployment sequence generated for the product release may be sent or otherwise provided to the client. At the client, the information about the optimal product deployment sequence may be presented to a user (e.g., the user who sent the request for a recommendation of an optimal product deployment sequence for the product release). For example, the information may be presented within a console GUI provided by test optimization service 508 on the client. The user can then take one or more appropriate actions based on the provided recommendation.

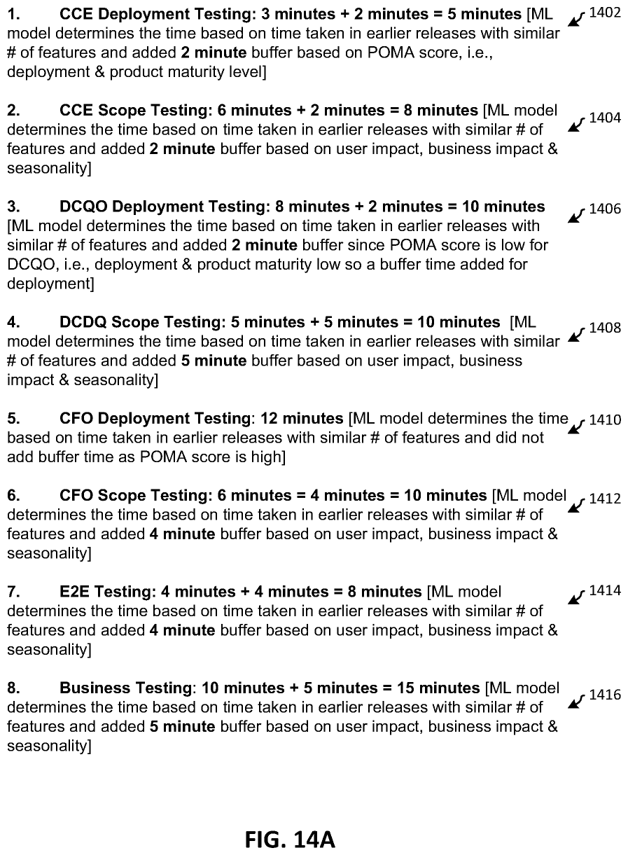

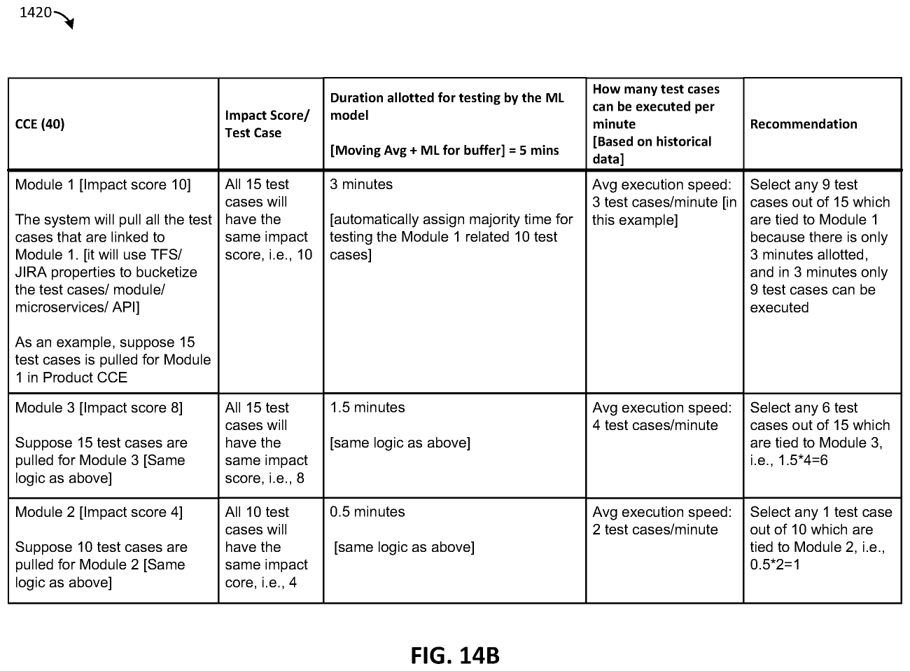

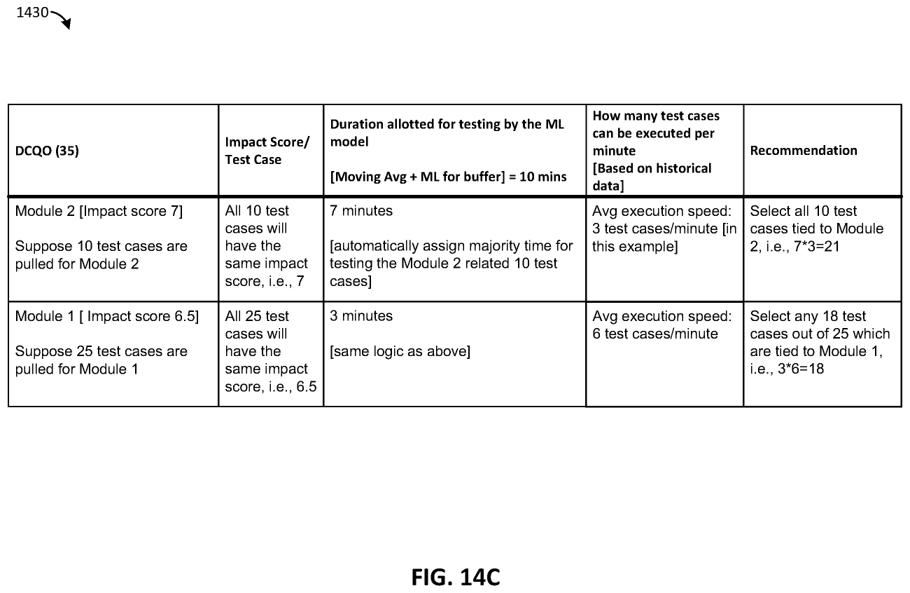

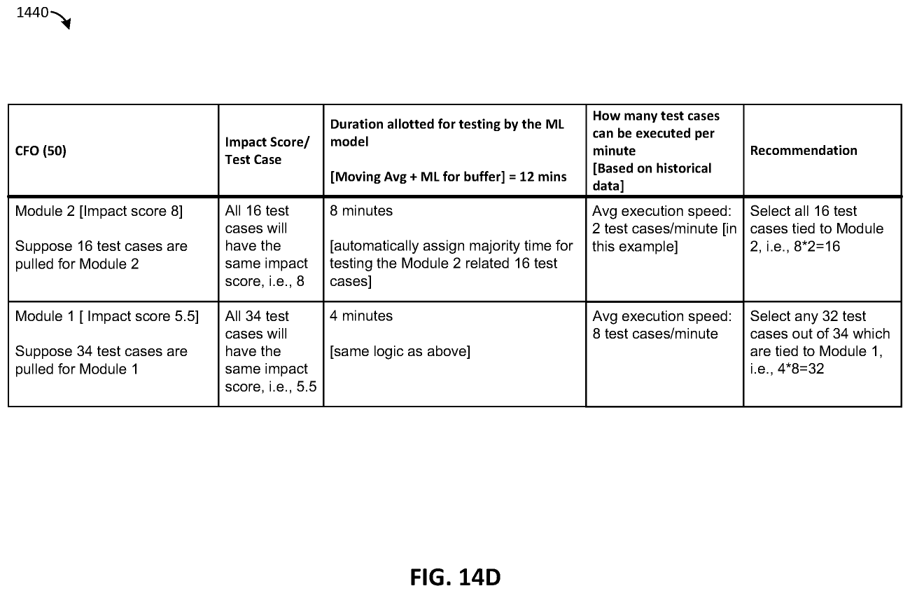

FIGS. 14A-14D illustrate an example of generating an optimal product deployment sequence for a product release, in accordance with an embodiment of the present disclosure. The illustrated example may be performed, according to some embodiments, by test optimizer module 516 of test optimization service 508 of FIG. 5 in response to a request for a request for a recommendation of an optimal product deployment sequence. For purposes of this discussion, it is assumed that the release is of a product CFO, the release number is 1102, the release of product CFO is a minor release, the deployment regions are Asia Pacific, Japan and China (APJC) and US, and the POMA score is 90%. For example, such information about the product release may be provided by a release manager and included with or as part of the request.

In response to the request, test optimizer module 516 can determine from requirement management system 524 the number of features that are to be deployed for product CFO. In this example, test optimizer module 516 can use the product name (CFO) and release number (1102) to determine that 10 features are to be deployed for product CFO for release 1102. Test optimizer module 516 can also determine from requirement management system 524 the interlocks linked to the product release. Continuing this example, test optimizer module 516 can use the release number (1102) to determine that product CCE and product DCDQ are the interlocks (i.e., dependent products) linked to the release number (1102). Then, for each interlock (e.g., for product CCE and product DCDQ), test optimizer module 516 can determine from requirement management system 524 the number of features that are to be deployed for the interlock. Continuing the example, test optimizer module 516 can use the release number (1102) to determine that 5 features are to be deployed for product CCE and that 10 features are to be deployed for product DCDQ for release 1102.

Test optimizer module 516 can determine a release sequence for release 1102 from data and information about historical deployments pulled from requirement management system 524. Test optimizer module 516 can also use the data and information about historical deployments to determine the probabilistic times it will take for the product and the interlocks for release 1102 (i.e., product CFO, product CCE, and product DCDQ) to deploy and test the 25 features (10+5+10) that are to be deployed for release 1102.

Continuing this example, referring to FIG. 14A which lists the actions to test the product and the interlocks in the release sequence, test optimizer module 516 can use ML services 508 to determine that product CCE deployment testing will take 5 minutes (see reference numeral 1402). For example, ML model 522c may determine that it will take 3 minutes for product CCE deployment testing based on the time taken in earlier releases with a similar number of features (e.g., moving average of the past 10 releases) and may determine that a 2 minute buffer is to be added based primarily on the POMA score for product CCE (e.g., based on the deployment and maturity level of product CCE). Similarly, test optimizer module 516 can use ML services 508 to determine that product CCE scope testing will take 8 minutes (see reference numeral 1404). For example, ML model 522c may determine that it will take 6 minutes for product CCE scope testing based on the time taken in earlier releases with a similar number of features and may determine that a 2 minute buffer is to be added based primarily on user impact, business impact, and seasonality associated with product CCE. Similarly, test optimizer module 516 can use ML services 508 to determine that product DCQO deployment testing will take 10 minutes (see reference numeral 1406). For example, ML model 522c may determine that it will take 8 minutes for product DCDQ deployment testing based on the time taken in earlier releases with a similar number of features and may determine that a 2 minute buffer is to be added based primarily on a low POMA score for product DCQO (e.g., based on low deployment and maturity levels of product DCDQ). Test optimizer module 516 can use ML services 508 to determine that product DCDQ scope testing will take 10 minutes (see reference numeral 1408), product CFO deployment testing will take 12 minutes (see reference numeral 1410), product CFO scope testing will take 10 minutes (see reference numeral 1412), E2E testing will take 8 minutes (see reference numeral 1414), and business testing will take 15 minutes (see reference numeral 1416). For example, ML model 522c may determine the testing times for product DCDQ scope testing, product CFO deployment testing, product CFO scope testing, E2E testing, and business testing in a manner similar to that described above for CCE deployment test, CCE scope testing, and DCDQ deployment testing (e.g., based on the time taken in earlier releases with a similar number of features and any determined buffer time that is to be added).

Continuing this example, test optimizer module 516 can compute a time to allot for performing any needed fixes during release 1102. The computed time may be for performing any needed fixes to product CFO and the interlocks, i.e., product CCE and product DCQO. For example, test optimizer module 516 can compute the time to allot for performing any needed fixes based on historic release data (e.g., based on the time allotted in earlier releases with a similar number of features). Test optimizer module 516 can also compute a time to allot for DevOps activities and applying configuration changes/settings during release 1102. For example, test optimizer module 516 can compute the time to allot for DevOps activities and applying configuration changes/settings based on historic release data (e.g., based on the time allotted in earlier releases with a similar number of features). Test optimizer module 516 can then generate an optimal product deployment sequence for release 1102 based on a planned start date and time for release 1102 provided by the release manager and included with the request. In some implementations, ML model 522c can generate the optimal product deployment sequence for release 1102 based on the planned start date and time for release 1102. An example of an optimal product deployment sequence which may be generated is discussed above with respect to FIG. 11.

In some embodiments, test optimizer module 516 can use ML services 508 to determine and assign impact scores to the various test cases that are to be executed during a product release. For example, test optimizer module 516 can determine from requirement management system 524 the number of test cases and/or the test cases that are linked to the 10 features that are to be deployed for product CFO in release 1102. Similarly, test optimizer module 516 can determine from requirement management system 524 the number of test cases and/or the test cases that are linked to the 5 features that are to be deployed for product CCE and the number of test cases and/or the test cases that are linked to the 10 features that are to be deployed for product DCDQ for release 1102. In this example, test optimizer module 516 can determine that 50 test cases are linked to the 10 features that are to be deployed for product CFO, 40 test cases are linked to the 5 features that are to be deployed for product CCE, and 35 test cases are linked to the 10 features that are to be deployed for product DCDQ.

In this example, turning to FIG. 14B, as shown in a table 1420, test optimizer module 516 can determine from requirement management system 524 that Module 1, Module 2, and Module 3 of product CCE are tied to release 1102. Test optimizer module 516 can also determine from requirement management system 524 that, of the 40 test cases linked to the 5 features that are to be deployed for product CCE, 15 test cases are for Module 1, 10 test cases are for Module 2, and 15 test cases are for Module 3. To assign the impact scores, test optimizer module 516 can use ML services 520 to determine impact scores for Module 1, Module 2, and Module 3. For example, ML model 522d may determine an impact score of 10 for Module 1, an impact score of 4 for Module 2, and an impact score of 8 for Module 3. Test optimizer module 516 can then assign an impact score to each of the 40 test cases based on the impact scores determined for Module 1, Module 2, and Module 3. For example, an impact score of 10 can be assigned to each of the 15 test cases that are for Module 1 since an impact score of 10 was determined for Module 1, an impact score of 4 can be assigned to each of the 10 test cases that are for Module 2 since an impact score of 4 was determined for Module 2, and an impact score of 8 can be assigned to each of the 15 test cases that are for Module 3 since an impact score of 8 was determined for Module 3. Test optimizer module 516 can then apportion the 5 minutes that was determined for product CCE deployment testing (refer to reference numeral 1402 in FIG. 14A) to testing of Module 1, Module 2, and Module 3 of product CCE. In some implementations, the testing time determined for testing the product may be apportioned to the modules of the product based on the impact score determined for the modules. For example, based on the impact scores determined for Module 1, Module 2, and Module 3, test optimizer module 516 can apportion 3 minutes for testing the 15 test cases that are for Module 1, 0.5 minutes for testing the 10 test cases that are for Module 2, and 1.5 minutes for testing the 15 test cases that are for Module 5. Test optimizer module 516 can determine from data and information about historical deployments the number of test cases that can be executed in a given duration (e.g., average execution speed of the test cases per minute). For example, test optimizer module 516 can determine from historical deployment data that 3 test cases can be executed per minute on average for the 15 test cases that are for Module 1, 2 test cases can be executed per minute on average for the 10 test cases that are for Module 2, and 4 test cases can be executed per minute on average for the 15 test cases that are for Module 3. Test optimization module 516 can then recommend the number of test cases to execute for each of the modules of a product based on the time apportioned for testing the test cases associated with the module and the average execution speed determined for the test cases. For example, test optimizer module 516 can recommend 9 of the 15 test cases that are for Module 1 to execute since 9 test cases can be executed in the 3 minutes apportioned for testing the test cases that are for Module 1, recommend 1 of the 10 test cases that are for Module 2 to execute since 1 test case can be executed in the 0.5 minutes apportioned for testing the test cases that are for Module 2, and recommend 6 of the 15 test cases that are for Module 3 to execute since 6 test cases can be executed in the 1.5 minutes apportioned for testing the test cases that are for Module 3. In some embodiments, test optimizer module 516 can select the actual test cases that are to be executed. For example, test optimizer module 516 can arbitrarily select 9 of the 15 test cases that are for Module 1, 1 of the 10 test cases that are for Module 2, and 6 of the 15 test cases that are for Module 3.

Continuing the example, turning to FIG. 14C, as shown in a table 1430, test optimizer module 516 can determine from requirement management system 524 that Module 1 and Module 2 of product DCQO are tied to release 1102. Test optimizer module 516 can also determine from requirement management system 524 that, of the 35 test cases linked to the 10 features that are to be deployed for product DCDQ, 25 test cases are for Module 1 and 10 test cases are for Module 2. To assign the impact scores, test optimizer module 516 can use ML services 520 to determine impact scores for Module 1 and Module 2. For example, ML model 522d may determine an impact score of 6.5 for Module 1 and an impact score of 7 for Module 2. Test optimizer module 516 can then assign an impact score to each of the 35 test cases based on the impact scores determined for Module 1 and Module 2. For example, an impact score of 6.5 can be assigned to each of the 25 test cases that are for Module 1 since an impact score of 6.5 was determined for Module 1 and an impact score of 7 can be assigned to each of the 10 test cases that are for Module 2 since an impact score of 7 was determined for Module 2. Test optimizer module 516 can then apportion the 10 minutes that was determined for product DCDQ deployment testing (refer to reference numeral 1406 in FIG. 14A) to testing of Module 1 and Module 2 of product DCDQ. For example, based on the impact scores determined for Module 1 and Module 2, test optimizer module 516 can apportion 3 minutes for testing the 25 test cases that are for Module 1 and 7 minutes for testing the 10 test cases that are for Module 2. Test optimizer module 516 can determine from data and information about historical deployments the number of test cases that can be executed in a given duration (e.g., average execution speed of the test cases per minute). For example, test optimizer module 516 can determine from historical deployment data that 6 test cases can be executed per minute on average for the 25 test cases that are for Module 1 and 3 test cases can be executed per minute on average for the 10 test cases that are for Module 2. Test optimizer module 516 can then recommend 18 of the 25 test cases that are for Module 1 to execute since 18 test cases can be executed in the 3 minutes apportioned for testing the test cases that are for Module 1 and recommend all 10 test cases that are for Module 2 to execute since all 10 test cases can be executed in the 7 minutes apportioned for testing the test cases that are for Module 2.

Continuing the example, turning to FIG. 14D, as shown in a table 1440, test optimizer module 516 can determine from requirement management system 524 that Module 1 and Module 2 of product CFO are tied to release 1102. Test optimizer module 516 can also determine from requirement management system 524 that, of the 50 test cases linked to the 10 features that are to be deployed for product CFO, 34 test cases are for Module 1 and 16 test cases are for Module 2. To assign the impact scores, test optimizer module 516 can use ML services 520 to determine impact scores for Module 1 and Module 2. For example, ML model 522d may determine an impact score of 5.5 for Module 1 and an impact score of 8 for Module 2. Test optimizer module 516 can then assign an impact score to each of the 50 test cases based on the impact scores determined for Module 1 and Module 2. For example, an impact score of 5.5 can be assigned to each of the 34 test cases that are for Module 1 since an impact score of 5.5 was determined for Module 1 and an impact score of 8 can be assigned to each of the 16 test cases that are for Module 2 since an impact score of 8 was determined for Module 2. Test optimizer module 516 can then apportion the 12 minutes that was determined for product CFO deployment testing (refer to reference numeral 1410 in FIG. 14A) to testing of Module 1 and Module 2 of product CFO. For example, based on the impact scores determined for Module 1 and Module 2, test optimizer module 516 can apportion 4 minutes for testing the 34 test cases that are for Module 1 and 8 minutes for testing the 16 test cases that are for Module 2. Test optimizer module 516 can determine from data and information about historical deployments the number of test cases that can be executed in a given duration (e.g., average execution speed of the test cases per minute). For example, test optimizer module 516 can determine from historical deployment data that 8 test cases can be executed per minute on average for the 34 test cases that are for Module 1 and 2 test cases can be executed per minute on average for the 16 test cases that are for Module 2. Test optimizer module 516 can then recommend 32 of the 34 test cases that are for Module 1 to execute since 32 test cases can be executed in the 4 minutes apportioned for testing the test cases that are for Module 1 and recommend all 16 test cases that are for Module 2 to execute since all 16 test cases can be executed in the 8 minutes apportioned for testing the test cases that are for Module 2.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a request for a recommendation of an optimal product deployment sequence for a product release from another computing device;
determining, by the computing device, a plurality of products associated with the product release, the plurality of products including a product that is being released and one or more interlocks linked to the product release;
determining, by the computing device, a number of features that are to be deployed for each product of the plurality of products;
determining, by the computing device, a testing that is to be performed for each product of the plurality of products;
determining, by the computing device using one or more machine learning (ML) models, a probabilistic time to test the features that are to be deployed for each product of the plurality of products, wherein the one or more ML models are configured to determine weights applied to parameters that influence performance of the one or more ML models;
generating, by the computing device, the optimal product deployment sequence for the product release based on a release sequence determined from historical deployments and the probabilistic times to test the features that are to be deployed; and
sending, by the computing device, information about the optimal product deployment sequence generated for the product release to the another computing device.

2. The method of claim 1, wherein at least one ML model of the plurality of ML models includes a ridge regression algorithm.

3. The method of claim 1, wherein at least one ML model of the plurality of ML models includes a linear regression algorithm.

4. The method of claim 1, wherein at least one ML model of the plurality of ML models includes an XGBoost algorithm.

5. The method of claim 1, wherein the probabilistic time to test the features that are to be deployed for each product of the plurality of products includes a buffer time.

6. The method of claim 5, wherein the buffer time is determined using the one or more ML models.

7. The method of claim 6, wherein the buffer time is determined based on a Product Operations Maturity Assessment (POMA) score.

8. The method of claim 6, wherein the buffer time is determined based on one or more of a change failure rate, number of defects raised during deployments, or time taken to complete previous deployments.

9. The method of claim 1, further comprising, by the computing device:
determining, for each product of the plurality of products associated with the product release, one or more test cases that are linked to the features that are to be deployed for the product; and
assigning to the one or more test cases an impact score, wherein the impact score is determined using the one or more ML models.

10. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a request for a recommendation of an optimal product deployment sequence for a product release from a computing device;
determining a plurality of products associated with the product release, the plurality of products including a product that is being released and one or more interlocks linked to the product release;
determining a number of features that are to be deployed for each product of the plurality of products;
determining a testing that is to be performed for each product of the plurality of products;
determining, using one or more machine learning (ML) models, a probabilistic time to test the features that are to be deployed for each product of the plurality of products, wherein the one or more ML models are configured to determine weights applied to parameters that influence performance of the one or more ML models;
generating the optimal product deployment sequence for the product release based on a release sequence determined from historical deployments and the probabilistic times to test the features that are to be deployed; and
sending information about the optimal product deployment sequence generated for the product release to the computing device.

11. The system of claim 10, wherein at least one ML model of the plurality of ML models includes one of a ridge regression algorithm, a linear regression algorithm, or an XGBoost algorithm.

12. The system of claim 10, wherein the probabilistic time to test the features that are to be deployed for each product of the plurality of products includes a buffer time.

13. The system of claim 12, wherein the buffer time is determined using the one or more ML models.

14. The system of claim 13, wherein the buffer time is determined based on a Product Operations Maturity Assessment (POMA) score.

15. The system of claim 13, wherein the buffer time is determined based on one or more of a user impact, a business impact, or a seasonality.

16. The system of claim 10, wherein the process further comprises:
determining, for each product of the plurality of products associated with the product release, one or more test cases that are linked to the features that are to be deployed for the product; and
assigning to the one or more test cases an impact score, wherein the impact score is determined using the one or more ML models.

17. A non-transitory machine-readable medium encoding instructions that when executed by one or more processors cause a process to be carried out, the process including:
receiving a request for a recommendation of an optimal product deployment sequence for a product release from a computing device;
determining a plurality of products associated with the product release, the plurality of products including a product that is being released and one or more interlocks linked to the product release;
determining a number of features that are to be deployed for each product of the plurality of products;
determining a testing that is to be performed for each product of the plurality of products;
determining, using one or more machine learning (ML) models, a probabilistic time to test the features that are to be deployed for each product of the plurality of products, wherein the one or more ML models are configured to determine weights applied to parameters that influence performance of the one or more ML models;
generating the optimal product deployment sequence for the product release based on a release sequence determined from historical deployments and the probabilistic times to test the features that are to be deployed; and
sending information about the optimal product deployment sequence generated for the product release to the computing device.

18. The machine-readable medium of claim 17, wherein at least one ML model of the plurality of ML models includes one of a ridge regression algorithm, a linear regression algorithm, or an XGBoost algorithm.

19. The machine-readable medium of claim 17, wherein the probabilistic time to test the features that are to be deployed for each product of the plurality of products includes a buffer time determined using the one or more ML models, wherein the buffer time is determined based on one or more of a Product Operations Maturity Assessment (POMA) score, a change failure rate, number of defects raised during deployments, or time taken to complete previous deployments.

20. The machine-readable medium of claim 17, wherein the process further comprises:
determining, for each product of the plurality of products associated with the product release, one or more test cases that are linked to the features that are to be deployed for the product; and
assigning to the one or more test cases an impact score, wherein the impact score is determined using the one or more ML models.
